(19) United States
(12) Patent Application Publication
(10) Pub. No.: US 2003/0040959 A1
(43) Pub. Date: Feb. 27, 2003

(54) Method and apparatus for conducting transactions on an automated teller machine

(76) Inventors: Calvin H. Fei, Walnut Creek, CA (US); Francis George Jacobs, San Bruno, CA (US); J. Mark Stockton, Bel Marin Keys, CA (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 09/925,972

(22) Filed: Aug. 10, 2001

(51) Int. Cl. G06F 17/60

(52) U.S. Cl. 705/14; 705/39

(57) ABSTRACT

Method and apparatus for conducting transactions on an automatic teller machine (ATM). A World Wide Web-enabled ATM provides messages, services and advertisements that are personalized and specifically targeted to the ATM user or that ATM user's market segment. The invention provides differentiated services to individual customers, targeted advertising to individuals and customer segments, quick transactions based on user-defined preferences, and customer-initiated electronic mail communication, which facilitates further marketing and sales activities related to the targeted advertisements.

### FIELD OF THE INVENTION

The present invention relates generally to the field of automated (or “automatic”) teller machines (typically referred to as “ATMs”), and more particularly to enhancing the customer's ATM session by providing messages, services and advertisements that are personalized and specifically targeted to that customer or that customer's market segment.

### RELATED ART

A growing number of banks and other financial institutions are using conventional ATM networks to deliver advertisements, special offers, notices and announcements to their customers. These ads and messages are usually presented to ATM users in the form of text messages printed in banner ads on a portion of the ATM's display screen, or printed on a coupon or receipt issued to the ATM user at the end of his or her transaction.

There are a number of problems associated with conventional ATM network technology that prevents companies from achieving significant impact or success in their efforts to generate new revenue by delivering ads and messages through their ATM networks. The vast majority of ATMs, for example, have very simple state-based operating systems, which only support old-fashioned, text-based user interfaces. Because the operating systems and user interfaces on these ATMs are so limited, they can process only a small number of relatively simple financial transactions. Moreover, the operating systems and user interfaces are not flexible enough to accommodate a complex two-way dialogue with an ATM user.

More recently, some ATM vendors, banks and other financial institutions have begun developing and installing ATMs that have sophisticated sound and video capabilities, which make it possible to play ads and announcements that include graphic images, audio and video clips.

However, the relatively limited functionality of the operating systems and user interfaces running on ATM terminals has resulted in heavy reliance by the ATM industry on relatively simple, functionally-limited network communication and information management technologies. These limited network communication and information management technologies have not provided fast and effective ways to identify an ATM user's particular set of interests, personal preferences and financial relationships during the course of an ATM session. Nor do these technologies provide an effective way to identify, at a group level, the ATM user's economic class or market segment.

Consequently, the ads and messages that are delivered to users through ATM networks—espite recent advances in ATM sound and display capabilities—usually consist of very simple, very generic, untargeted content, and provide no fast and easy way for the customer to respond. Under these circumstances, efforts to deliver ads and messages to users through ATM networks have had very little chance of making a noticeable impact in the advertising marketplace.

In cases where ads and messages are delivered via audio and/or video clips, another problem often arises. While ATM users generally like and appreciate the ATM's graphical features, they often do not wish to be held up waiting for an ad or message to finish before they are allowed to proceed to the next step in the transaction, or conduct a new transaction. Sometimes ATM users want to get into the system, obtain their cash or balance statement, and get out as quickly as possible without having the advertising delay or interrupt the transaction. Traditional ATM networks have not been designed in a way that provides an effective solution to this problem.

Accordingly, there is a need in the industry for an ATM machine and ATM network with sufficient communications and information management functionality to support delivering targeted ads, special offers, information and announcements to the ATM user during an ATM session in a personalized and unobtrusive fashion. There is a further need in the art to provide a mechanism for the ATM user to respond to these ads and announcements immediately. There is still a further need in the art for an ATM network and infrastructure that will deliver ads and announcements without slowing down or interrupting the ATM's processing of other transactions.

### SUMMARY OF THE INVENTION

As used herein, an ATM, also called an “automatic teller machine,” “cash machine” or “money machine,” is an unattended electronic machine, typically located in a public place, that is connected to a data communications network and related equipment, and activated by a user to obtain cash withdrawals, conduct transactions such as balance inquiries and funds transfers, and to obtain other products and services. As used herein, an ATM is not limited to a machine operated by a bank, credit union, or other financial institution. These machines can be, and usually are, located in banks, credit unions, shopping malls, grocery stores, or almost any other easily accessible location where, for example, people are likely to need cash.

The present invention is directed to a method and apparatus for conducting transactions on an ATM through the use of a Web-based ATM infrastructure. The invention provides differentiated services to individual customers, targeted advertising to individuals and customer segments, quick transactions based on user-defined preferences, and customer-initiated electronic mail communication, which facilitates further marketing and sales activities related to the targeted advertisements.

In general, the system comprises a “Web-enabled” ATM, connected through various transport and message level communications protocols, to a secure Web Server and a host mainframe server (described in more detail below), which provides financial transaction services. The Web-enabled ATM, or Web ATM, includes a browser and other Web-related technology, which allows the Web ATM to access and display HTML pages downloaded from the Web Server. The host machine provides financial transaction services.

One aspect of the present invention is a method for presenting a show on an ATM comprising the steps of: (1) providing access to a memory area containing a plurality of show elements; (2) associating a subset of the plurality of show elements with a market category; and, (3) in response to activation of the ATM by a user associated with the market category, (i) selecting one or more show elements from the subset to form a playlist, and (ii) displaying the show elements in the playlist to the user. For purposes of the invention, a “show element” may comprise any kind of media content that can be recorded, stored, or retrieved, played, presented or displayed by mechanical or electronic means, including but not limited to any kind of computerized device or piece of audio/video equipment. A show element might consist of, for example, a text message, an animation, a piece of clip art, a still image, an audio or video stream, or some combination of any or all of the above. A show element might also comprise a recording of one or more other show elements. A “show” collectively refers to a combination of one or more show elements, and a “playlist” is a list of show elements that have been selected for a show. Those of ordinary skill in the art would recognize and appreciate the fact that a “show,” as described herein, might also be referred to by various other names known in the art, including but not limited to, terms such as “movies,” “commercials,” “messages,” “announcements,” “demonstrations,” “presentations,” and the like.

In another aspect of this preferred embodiment, show elements are combined with other show elements, and then ordered, sorted or arranged into a show with a preferred sequence before displaying the show elements to a user. In developing the order of show elements in a show, the goal is to provide a variety of show elements to the user, to vary the order that the user sees those show elements, and to ensure that certain show elements (or certain shows) are played more often than others. One way, although certainly not the only way, to determine the order in which show elements are presented, is to use an algorithm (as described below with reference to FIGS. 8A-8D and 9) that assigns weights to each show element before sorting the show elements based on those weight assignments. Since the selection and weighting of show elements may be based on a wide variety of factors (such as the relative importance of a show element for a given customer profile and a given ATM location), the particular show elements played for a particular user, and the order in which those show elements are played can be quite dynamic. In this embodiment, the system can also be configured to play a set of default show elements whenever there is no user session in progress, or whenever the system fails to find an association between the customer profile or the ATM location on the one hand, and any particular set of show elements on the other.

In a preferred embodiment of this method, the market category may be defined by one or more market-related traits, such as possession of an access card containing a predetermined string of alphanumeric characters, a relationship or set of financial arrangements between the user and a bank, or a geographic location of the ATM. In a further aspect of the preferred embodiment, the show elements are selected from a list of show elements that have been previously associated with the particular access card, the particular user, or the particular ATM involved in the ATM transaction.

In still another aspect of the present invention, the user has access to an input control device, such as a keyboard, pointer, button or input dialogue box and the like, so that the user can provide an immediate response to any particular show or show element played by that ATM. Such user response might, for example, cause an electronic mail message to be sent to an appropriate person or entity (or to the user himself) when the user would like to obtain additional information about a particular show or show element. The follow up contact may also be provided via telephone, mail or banking center appointment.

In practicing the methods described herein in accordance with a preferred embodiment of the present invention, one could optionally configure an ATM to display shows substantially simultaneously with various ATM functions, such as: (1) prompting the user to enter a personal identification number, (2) prompting the user to select a transaction mode, (3) prompting the user to select an account, (4) processing a transaction request initiated by the user, (5) displaying a transaction request result, (6) dispensing an access card, (7) dispensing a receipt, or (8) any or all of the above. By way of example and not limitation, if an ATM user perceives an interruption or delay in the presentation of a show due to the ATM's processing of the user's input or the user's transaction request, then the show is not being displayed substantially simultaneously. Conversely, if an ATM user perceives an interruption or delay in the ATM's processing of the user's input or transaction request due to the presentation of a show, then the show is not being displayed substantially simultaneously.

In yet another aspect of the present invention, a method of dispensing cash from an ATM, is provided. The method comprises the steps of: (a) retrieving a set of user preferences from a memory area in response to an insertion of an access card in the ATM by a user; (b) receiving input from the user, wherein the input consists of accepting a personal identification number and a transaction mode entered by the user in response to instructions displayed on a single display screen; and (c) dispensing the cash to the user. In this embodiment, retrieving a set of user preferences (such as the preferred language or “fast cash” amount) from a memory storage area, and combining the request for a personal identification number and transaction selection into a single screen, allows the requested transaction to be processed without further dialogue with the user. This drastically reduces the amount of time required to complete the transaction for the user. Preferably, although not necessarily, the ATM can be configured to play targeted, personalized ads even while in this “quick transaction” mode.

Features and Advantages of the Present Invention

It is a feature of the present invention that it provides a “personalized” user interface for a segment of customers or an individual customer.

A further feature of the present invention is that it makes it possible to present targeted advertising to a user during the ATM session.

Yet another feature of the present invention is that it provides customers with a way to send an electronic mail message when the customer would like to receive additional information about an advertisement, product promotion or special offer.

Another advantage of the present invention is that it allows banks to strengthen their customer relationships by selling new products to customers through the ATM marketing channel, thereby providing increased revenue potential for a variety of products and services.

Still another advantage of the present invention is that it puts the bank in a better position to support a consistent customer experience across multiple delivery channels through the use of a robust customer information management system and customer-defined presentation styles.

It is another feature of the present invention to provide default ads for customers in the event that no user session is in progress, or when customer information and targeted ads are not available.

Additional features and advantages of the invention are set forth in part in the description that follows, and in part are apparent from the description, or may be learned by practice of the invention. The features and advantages of the invention may also be realized and attained by means of the instrumentalities and combinations particularly set out in the appended claims.

### BRIEF DESCRIPTION OF THE FIGURES

The accompanying drawings, which are incorporated in and constitute part of the specification, illustrate preferred embodiments of the invention, and, together with the description, serve to explain the principles of the present invention. In the drawings, like reference numbers indicate identical or functionally similar elements. Additionally, the left-most digit(s) of a reference number identifies the drawing in which the reference number first appears.

FIG. 1 depicts a block diagram of one embodiment of an apparatus for conducting transactions on an automated teller machine according to the present invention.

FIG. 2 depicts a block diagram of one embodiment of a Web-Enabled ATM according to the present invention.

FIG. 3 depicts a block diagram illustrating one embodiment of a secure Web Server and several application servers configured according to the present invention.

FIG. 4 shows a block diagram of a host mainframe according to an embodiment of the present invention.

FIG. 5. shows a block diagram of another embodiment of an apparatus for conducting transactions on an ATM according to the present invention.

FIG. 6 shows yet another block diagram of an apparatus for conducting transactions on an ATM according to the present invention, this one including content and software distribution services, as well as monitoring of Microsoft Windows NT® objects.

FIG. 7 shows an example of a layout of screen zones that could be used in an embodiment of the present invention.

FIGS. 8A, 8B, 8C and 8D show a flow diagram illustrating the steps that could be used to select advertisements for play in one embodiment of the present invention.

FIG. 9 shows a flow diagram illustrating the steps that could be used to assign play order weights to ads in one embodiment of the present invention.

FIG. 10 shows a data flow diagram of a “quick transaction” according to one embodiment of the present invention.

FIG. 11 shows an exemplary embodiment of a user interface screen which can be used with the present invention to accept a personal identification number and transaction selection from a user.

FIG. 12 is a data flow diagram illustrating the flow of data which takes place in a customer email transaction according to one embodiment of the present invention.

FIG. 13 depicts an exemplary user interface screen which can be used with the present invention to implement the customer email feature.

FIG. 14 is a data flow diagram illustrating the flow of data which takes place during a customer session according to one embodiment of the present invention.

FIG. 15 is a data flow diagram illustrating the flow of data that occurs in one embodiment of the present invention which implements the targeted advertising feature.

FIGS. 16, 17 and 18 contain exemplary user interface screens for an administrative panel for an advertising database suitable for use with one embodiment of the present invention.

FIGS. 19-38 depict exemplary embodiments of user interface display screens which can be used with the present invention.

### DETAILED DESCRIPTION OF THE PREFERRED EMBODIMENTS

Reference will now be made in detail to the preferred embodiments of the invention, examples of which are illustrated in the accompanying drawings. Notably, the present invention may be implemented using software, hardware or any combination thereof, as would be apparent to those of skill in the art, and the figures and examples below are not meant to limit the scope of the present invention or its embodiments or equivalents.

Overview of the Present Invention

The present invention uses information stored in a banking, financial, or other institution's databases to differentiate customers using its ATMs. Based on the customer's preferences and financial relationships, as well as the geographic location of the ATM, the present invention provides a facility for delivering more personalized user interface or “look and feel” on the ATM screen during the ATM transaction.

The present invention also provides a way to show advertising to specific targeted customers based upon predefined marketing data. These ads target specific individuals or specific groups of individuals based on, for example, the type of financial programs the customer participates in, on an access card account number, on the geographic location of the ATM, or all of the above.

In a preferred embodiment, the order in which ads are displayed can be arranged according to a priority scheme thought most likely to achieve the maximum impact on the customer. For instance, one might adopt a priority scheme designed to give top priority to ads targeted for the individual customer, followed by ads for the customer segment near the ATM's geographic location, followed by ads based on the type of access (or debit) card used, followed by the default ads for the system.

Detailed Operation of the Present Invention

An ATM is typically linked through a communications network to a BASE24 host server. A BASE24 host server is a mainframe computer that handles the financial transaction and error messages that occur when a user activates the ATM. The communication of messages between the ATM and the BASE24 host server is accomplished via an industry standard message-layer protocol known as Diebold Direct Connect (“DDC”) 912. Further information on the DDC 912 message-layer protocol can be found in the Manual entitled, “Interbold i Series/MDS Terminal Programming Manual (April 1995), which is incorporated herein by reference in its entirety.

Web ATM

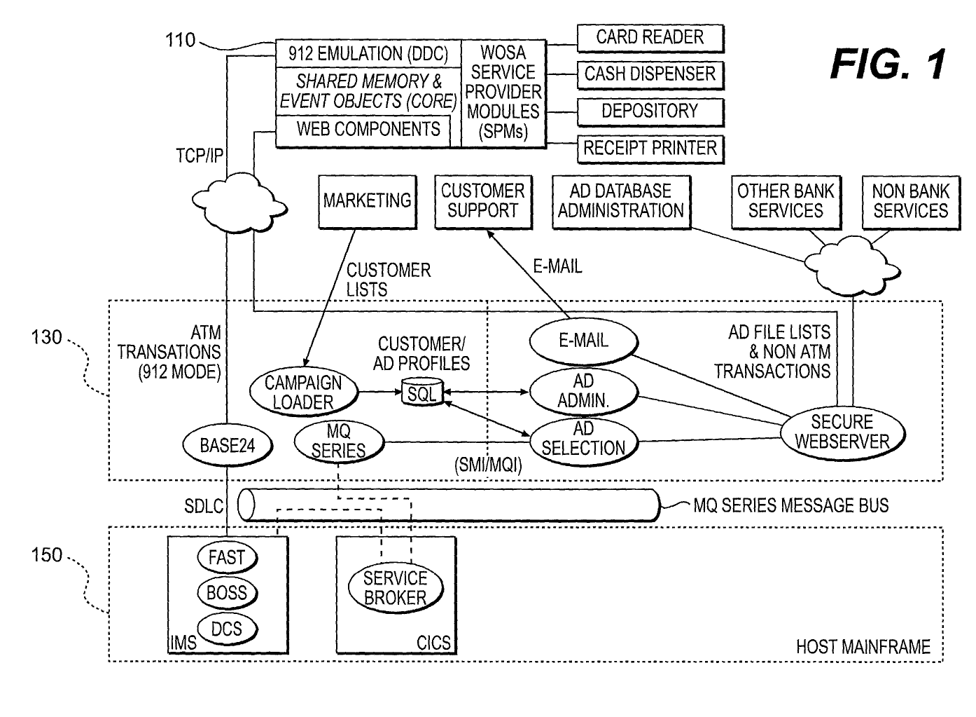

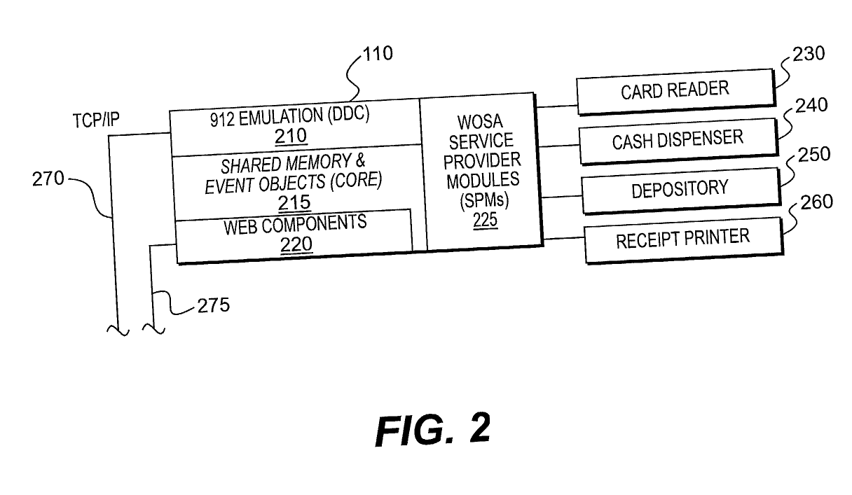

In accordance with a preferred embodiment of the present invention (and as depicted in FIGS. 1 and 2) a “Web-enabled,” ATM 110 is provided. The term “Web-enabled” in this context means that the traditional text-based ATM displays have been replaced with browser-displayed hyper-text markup language (“HTML”) pages. Accordingly, the Web ATM 110 uses World Wide Web browser and server technology (depicted as Web Components 220 in FIG. 2). Returning again to FIG. 1, Web ATM 110 is connected, via a router-based frame relay network interface, to a Host Mainframe 150. Host Mainframe 150 is a BASE24-compliant server. An industry standard protocol, known as Transmission Control Protocol/Internet Protocol (“TCP/IP”), provides transport layer communications between Web ATM 110 and Host Mainframe 150. In addition to the Host mainframe 150, Web ATM 110 is also connected to a Web Server 130, which supports the ad content to be displayed during ATM transactions to provide the enhanced functionality described above.

Now referring to FIG. 2, in a preferred embodiment, Web ATM 110 is based on an ATM software product, known as ATM w/Web Extensions (available from International Business Machines Canada). This product runs under Windows NT® (available from Microsoft Corporation of Redmond, Wash.) and employs browser technology for screen presentation, and JavaScript functions to support dynamic HTML pages. (JavaSript™ is available from Netscape Communications of Mountain View, Calif.). Standard Windows Open System Architecture (“WOSA”) application programming interfaces (“APIs”) (depicted with reference number 225 in FIG. 2) are used for device control over the Web ATM's peripherals (e.g., card reader, keypad, cash dispenser, depository and receipt dispenser).

ATM transactions are supported by the ProCash DDC (Diebold Direct Connect) 912 emulation software 210 (available from Siemens Nixdorf of Munich, Germany) with Web extensions that allow the display of HTML pages on the Web ATM in place of the standard text-based screens. The Web Extensions software also provides the ability to put additional options on the DDC menus that allow access to services and pages from a Web Server. The Web Extensions software also allows the Web server to access Web ATM peripheral devices, such as the keyboard and printer 260, so that they can be used to interact with the ATM customer. In a preferred embodiment, the Web Extensions software and the emulation software communicate with each other via shared memory and event objects, depicted in FIG. 2 as 215.

Network Access

In a preferred embodiment, network access for the ATM is accomplished through an Ethernet LAN and Cisco Systems (San Jose, Calif.) router using TCP/IP. The router provides gateway services into the frame relay-based Model Digital Network. TCP/IP is the industry standard protocol for Web-based transactions. One of ordinary skill in the art would recognize and appreciate that a system built in accordance with the present invention may use alternate transport layer protocols for communications between the Web-enabled ATM and the BASE24 host server. However, using the TCP/IP protocol allows “tunneling” and has no negative impact on BASE24 transaction security. “Tunneling” is a technique by which a private corporation extends its own network by establishing a “virtual private network” (VPN) over the public Internet.

As stated above, in a preferred embodiment, a BASE24 host server handles messaging for financial transactions and errors. BASE24, however, is not the only platform on which the present invention may be implemented. Those skilled in the art would recognize that the present invention could also be implemented using any number of other host server platforms, including, for example, Connex, IMS, or Microsoft Windows NT.® If a problem related to the Web server path is encountered by the Web ATM, the Web ATM generates a nonstandard unsolicited status message. Accordingly, the BASE24 device handlers used for the Diebold 912 emulation mode in a standard ATM are configured in the preferred embodiment of the present invention, to recognize and parse new statuses and log appropriate error messages for the ATM monitoring system(s). ACI Worldwide™ of Omaha, Nebr., provides a BASE24 product suitable for implementation of the present invention in accordance with the preferred embodiment as herein described.

From the perspective of the BASE24 server, the Web ATM appears to be a standard MDS (Modular Delivery System) ATM using 912 emulation mode messages over TCP/IP protocol. The secure Web Server provides support for uniform resource locator (“URL”) requests, delivers HTML and Java applets to the Web ATM for supported transactions, and routes messages from the Web ATM client to the appropriate application server using Common Gateway Interface (CGI) protocol. CGI is an industry standard for connecting an application server to a Web server.

Web Server

In a preferred embodiment, the Web Server runs in an environment for portable applications, such as the Open System Services (OSS) environment (available from Compaq Computers of Houston, Tex.). OSS is based on the X/OPEN CAE specifications, which implements the POSIX 1 and POSIX 2 standards, and the UNIX KORN shell. Most OSS commands and utilities have a direct counterpart in UNIX. Others are unique and provide interoperability with Tandem's environment. This is very useful if it becomes necessary to access ATM information maintained in BASE24 files.

When the Web server receives input from a Web ATM, it may satisfy the request by downloading a requested document (e.g., Web page) or may forward the request to an application server whose results are returned to the requesting Web ATM. These application servers provide session and transaction integrity, as well as directory and gateway services to Web Service providers. They also provide translation and formatting functions between the Web ATM and the service providers, and manage the configuration and monitor the availability of the Web ATM.

The application servers provide the following functions:

Routing transaction requests to the proper destination and provide any necessary message translation;

Managing the Web ATM session and transactions, and perform any recovery and notification as necessary;

Initiating and managing any gateways to servers that provide services for the Web ATM;

Providing Directory services that define the transactions available at the Web ATM and the destinations that can provide those services; and

Monitoring the Web ATM and server components and support any network management or software distribution requests.

In the preferred embodiment, the JAVA programming language is used wherever possible so that code is re-usable and portable as much as possible. These application programs can be implemented as Java servlets that receive requests via a CGI interface. They can receive information from the Web server through environment variables and standard input, and return dynamically-generated Web content via standard output. The Web Server 130 is then responsible for returning the information to the ATM client. The Servlet Server Class (SSC) allows CGI applications to be written as Java servlets.

When a user activates an ATM, the Web ATM application obtains user profile information from a CICS-based Service Broker application via a MQ Series Message Bus. MQ Series software (available from International Business Machines) provides application-programming services that enable processes on different nodes on a variety of machines and operating system types to communicate with each other using message queues. It also provides a common API called the Message Queue Interface or MQI, so that programs developed on one platform can be readily transferred to another. MQ Series takes care of network interfaces, assures delivery, deals with communication protocols, and handles recovery after system problems. In a preferred embodiment, both TCP/IP and SNA (System Network Architecture) network protocols are supported.

A Service Broker on the host receives requests from its Service Request Queue and invokes the appropriate script based on a standard header. A Service script contains workflow logic to satisfy the client service request. The request is translated into a host application request or requests, and messages are sent across the Message Bus to the appropriate host application(s). The host application response(s) are then reformatted into a client response in a Standard Message Interface (SMI) format.

SMI is based on the Business Object Document Model (BOD). The Business Object Document (BOD) is used to communicate a request from a requesting application to a destination business application (such as the Service Broker). In turn, the destination business application returns a Business Object Document response. Each BOD is a self-defining message that includes all the business details needed by applications using the SMI APIs.

The Standard Message Interface (SMI) allows a calling program to either encode or decode an Open Applications Group (OAG) message using a set of API calls. These APIs use a message handle to keep track of the state of the encode/decode process for a given message and provide consistent return area information about the success of an API call. All of the APIs are also available to Java classes through the SMI package that implements a Java Native Interface (JNI) to these APIs.

The present invention incorporates two types of technology into one system: state/screen-based technology used between the ATM and the BASE24 system; and client/server-based technology used by the Web ATM and the Web Server 130. Non-Web ATM processing is state based in that the ATM evaluates the current screen plus any customer input to determine the next action or the next display to present. With the advent of the Web ATM, each time the screen or state changes, web-type services may be invoked. For example, the Web ATM administrator can define specific ad content that: (1) positions ads in particular places on the ATM screen, (2) plays ads at specific times before and during a customer session, and (3) selects specific ads based on certain criteria that is a combination of the ATM, the customer, and the currently available content.

The position of an ad on a display screen is defined by the particular ad type (e.g., teaser ads play in the banner zone at the bottom of the display screen). Ads can be configured to play without interruption throughout an entire transaction, or terminate when the state of the Web ATM changes. The Web ATM of the present invention utilizes specially defined, or dedicated, states which effectively suspends the operation of other old-style state logic functions, while the Web ATM is engaged in Web-based transactions. These specially defined states (e.g., state 13) provides a virtual “door” to the World Wide Web without requiring extensive modifications of a traditional ATM's state-based operating system.

With reference now to the figures, a more detailed description of the preferred embodiment is now provided. FIG. 1 shows a block diagram of a preferred embodiment of an apparatus for conducting transactions on an ATM in accordance with the present invention. Generally, the apparatus comprises a Web ATM 110, a Web Server 130 and a Host Mainframe 150, all interconnected via a data communications network. The data network could be, but does not have to be, a private intranet, the public Internet, or some combination of both. Although the Web ATM 110, Web Server 130 and Host Mainframe 150 are shown in FIG. 1 (and the figures that follow FIG. 1) as separate machines, one of skill in the art would recognize that a system that combined the functionality of the three machines in the same physical device or the same physical location would not depart from the scope of the present invention.

FIGS. 2, 3 and 4 contain more detailed views of the three components depicted in FIG. 1. Accordingly, FIG. 2 shows Web ATM 110 in greater detail. Web ATM 110 is comprised of a 912 Emulation (DDC) Emulation Software 210, Shared Memory & Event Objects Core 215, Web Components 220 and Windows Open Systems Architecture (“WOSA”) Service Provider Modules (“SPMs”) 225. In this embodiment, the WOSA SPMs 225 provide device control interfaces to any peripherals installed in Web ATM 110, including Card Reader 230, Cash Dispenser 240, Depository 250, Receipt Printer 260. Although not depicted in FIG. 2, Web ATM 110 typically would include other peripherals, such as a keypad or keyboard, a monitor, a video camera, and the like, which, in the preferred embodiment, may also be controlled through WOSA SPMs 225.

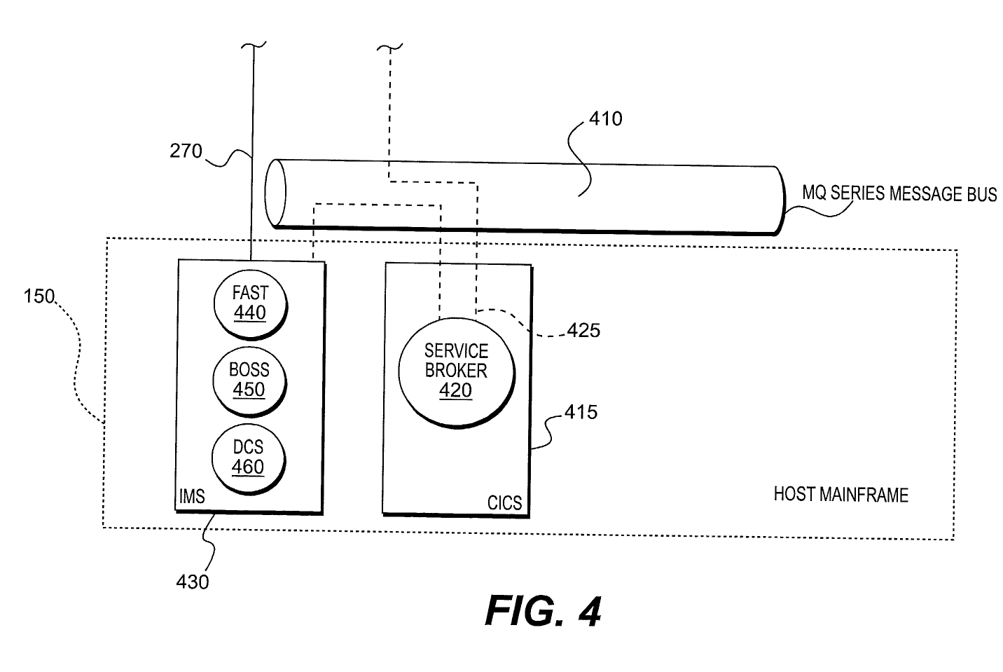

Web Components 220 usually, but not necessarily, comprises a browser program, such as Windows Internet Explorer 5.0,™ (available from Microsoft Corporation, Redmond, Wash.), and other Web-related technologies making it possible for Web ATM 110 to access, retrieve and display HTML pages. Shared Memory & Event Objects Core 215 recognizes and parses nonstandard unsolicited error messages and statuses generated by Web ATM 110, and passes this information to the 912 Emulation Software 210. 912 Emulation Software 210 is coupled, through a data communications network 305, to Host Mainframe 150 (discussed below with reference to FIG. 4) via TCP/IP-based LAN connections 270 and 275.

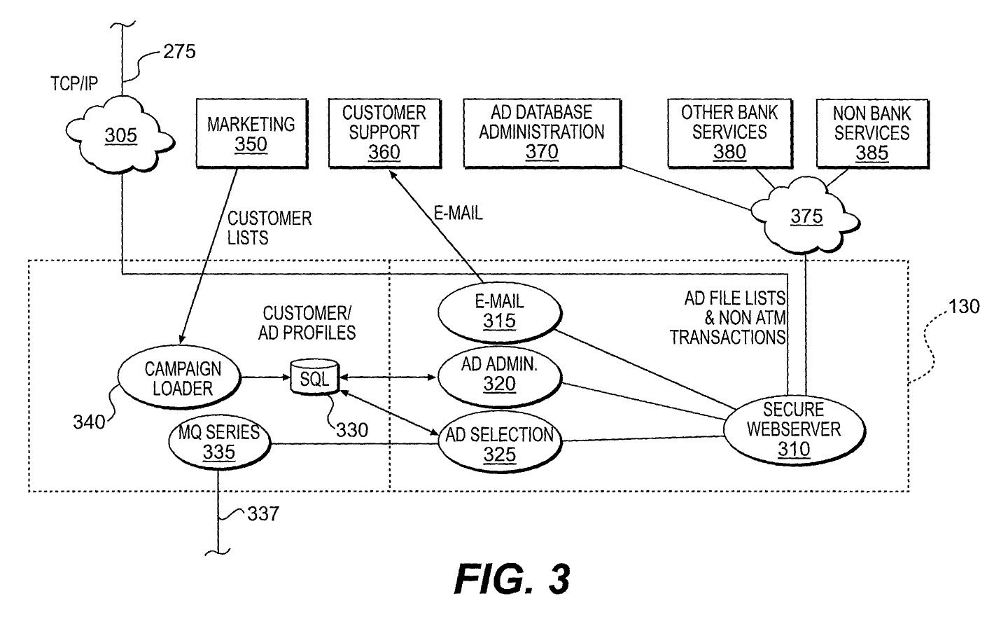

FIG. 3 shows Web Server 130 in more detail. Web Server 130 comprises Secure Web Server 310, and a number of subsystem modules for handling various functions, including E-mail 315, Ad Admin 320, Ad Selection 325, Customer Ad Profiles 330, Campaign Loader 340, and MQ Series Software (depicted in FIG. 3 as MQ Series 335). Module E-mail 315 handles electronic mail between Web ATM 110 users and an ad campaign internal or external product manager. Ad Admin 320 and Ad Selection 325, in conjunction with an SQL database (Customer Ad Profile 330 in FIG. 3), are used to configure, select and sequence the advertisements that will play during a customer session on the Web ATM 110. In a preferred embodiment, Web Server 130 is also connected through data communications network 375, to several Web-based application servers. FIG. 3 illustrates five such applications servers which might be coupled to Web Server 130 in accordance with the invention, including Marketing 350, Customer Support 360, Ad Database Administration 370, Other Bank Services 380 and Non-Bank Services 385. Finally, Web Server 130 includes MQ Series 335, provides application-programming services that enable processes on different nodes on a variety of machines and operating system types to communicate with each other using message queues. It also provides a common API called the Message Queue Interface or MQI, so that programs developed on one platform can be readily transferred to another. MQ Series 335 is coupled, through a LAN connection 337 to Host Mainframe 150 through MQ Series Message Bus 410 (shown in FIG. 4).

Host Mainframe 150, shown in more detail in FIG. 4, comprises a CICS 415, a Service Broker 420, which handles service requests from Web Server 130, and IMS 430, which provides an operating environment for a number of standard financial transaction applications, including: FAST 440, for online account transaction processing, BOSS 450, which manages access (or debit) card account linking information, and DCS 460, which manages access (or debit) card authorization services. CICS 415 is linked through MQ Series Bus 410 to Web Server 130, and through link 425 to IMS 430.

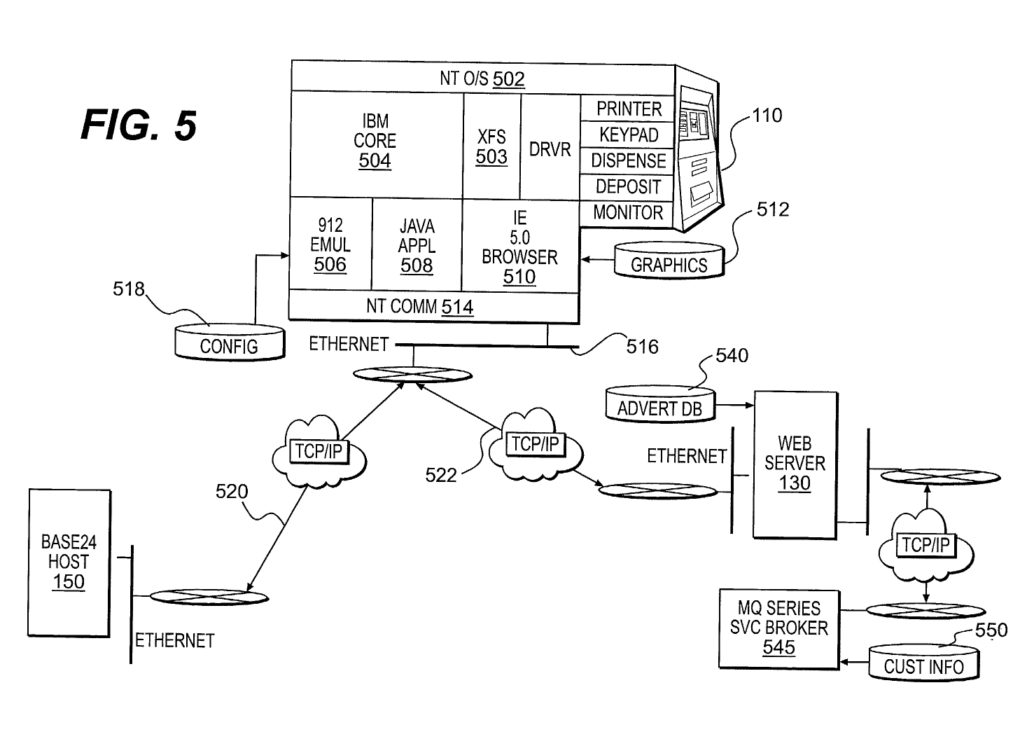

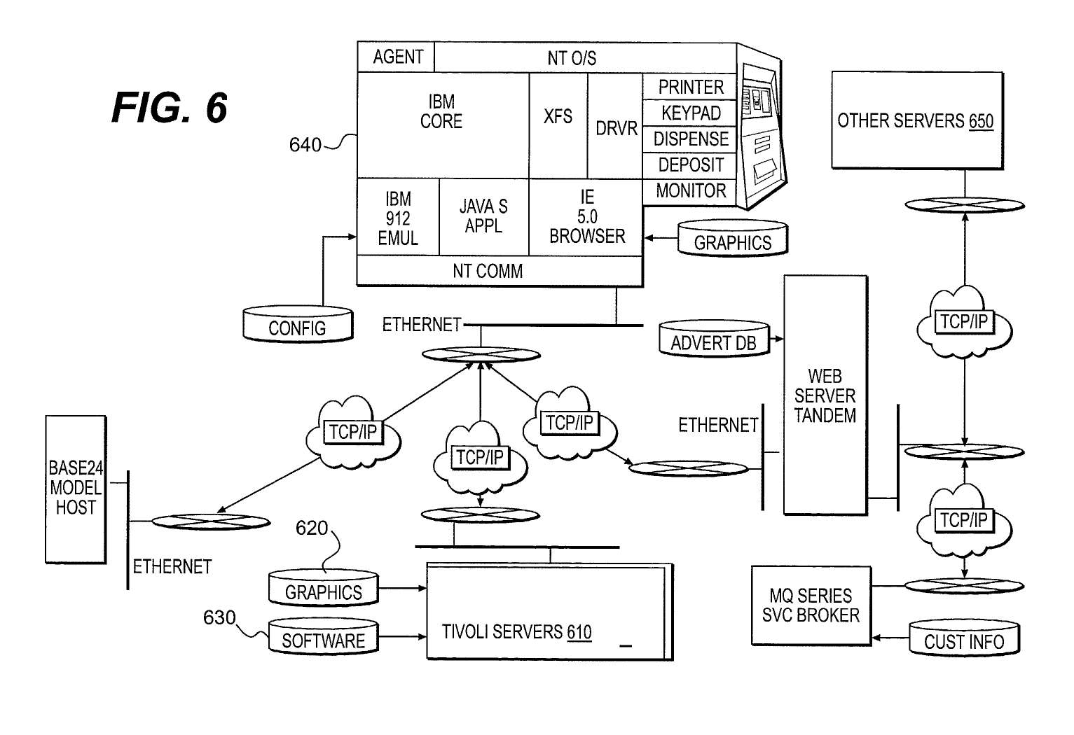

FIGS. 5 and 6 contain two additional block diagrams of preferred embodiments of the invention. As can be seen in FIG. 5, Web ATM 110 further comprises Financial Service Extensions (depicted in FIG. 5 as XFS DRVR 503), JAVA application software (shown as JAVA APPL 508), Windows NT Communications Software (shown as NT COMM 514), a Windows NT Operating System (NT O/S 502), and a graphics database (GRAPHICS 512). In this embodiment, Web ATM 110 also includes a configuration module (CONFIG 518) for handling configuration tasks, an IBM Core 504, a 912 Emulation subsystem 506, and an Internet Explorer 5.0 Browser 510, for accessing and displaying HTML pages. Web ATM 110 is connected to a BASE24 Host 150 and Web Server 130 via network connections 516, 520 and 522. Web Server 130, in the preferred embodiment includes an advertisement database 540 and is coupled to an MQ Series Service Broker 545. The MQ Series Service Broker 545 further includes access to a customer information database 550.

FIG. 6 is almost identical to FIG. 5, except that it also depicts the addition of an optional subsystem for distributing content and software, and monitoring NT objects sent by Web ATM 110. The distribution and monitoring subsystem in the embodiment shown in FIG. 6 (available from Tivoli Systems, Inc. of Austin, Tex.) comprises Server 610, a graphics database (shown as GRAPHICS 620), a software storage area (SOFTWARE 630), and Agent 640, which resides on Web ATM 110. Unlike FIG. 5, FIG. 6 also illustrates an additional TCP/IP connection between Web Server 130 and other application servers (shown in FIG. 6 as Other Servers 650).

Web ATM Screen Zones

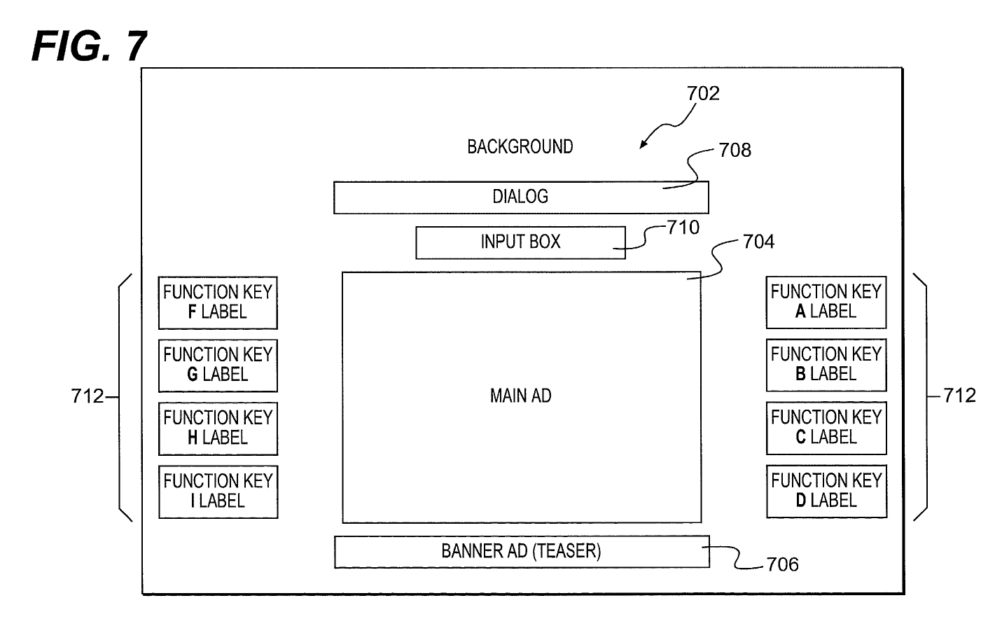

In a preferred embodiment, the Web ATM display screen is partitioned into several visual “zones.” These zones will be used for different functions. FIG. 7 illustrates one example-although certainly not the only example—of the kind of Web ATM screen zones that could be defined in accordance with the present invention.

Background (reference number 702 in FIG. 7)—this visual zone extends over the entire consumer screen area and provides a context for the other zones. The other zones are overlaid on top of the background. The background will contain brand information and logos that represent the corporate image.

Main (reference number 704 in FIG. 7)—this visual zone is centered on the background and is generally used to present the major advertising material. Typically this zone will display animated or video “film clips”. In one embodiment, the main ad space has three different categories of ads: “Attract” ads play when there is no customer using the ATM. Attract ads are generally video clips that play in a repeating loop. These ads may or may not contain audio material, depending on the nature of the product advertised. Targeted shows play when there is a customer using the ATM. After the customer is identified via the card read, ads that have been specified for this customer will be activated. The Targeted shows will play throughout the customer session. These shows may contain audio material. Closer shows play at the end of the customer session. Closer shows will be activated when the customer has elected to terminate a session. In one embodiment, these shows will play while the customer is retrieving the card, the receipt, or any cash or coupons. These shows may also contain audio material.

Banner (reference number 706 in FIG. 7)—this visual zone is centered at the bottom of the screen area. Additional advertising material will be played in this zone. This ad space can be used for “Teaser” ads that change throughout the session or for “specials” that are specific to that location.

Dialog Box (reference number 708 in FIG. 7)—this visual zone contains the customer instructions during the ATM session. The customer will be prompted with text displayed in this zone to “select a function” or “enter their PIN”.

Input Box (reference number 710 in FIG. 7)—this visual zone is centered in the middle of the screen and overlays the Main Ad zone. The Input box is used whenever customer information is requested from the numeric keypad. As customers type numbers from the keypad, they will be displayed in the Input Box. Certain privacy elements such as PIN data may be displayed, for example, as asterisks or pound signs.

Function Key Labels (reference number 712 in FIG. 7)—in addition to the numeric keypad, the customer will also use the Web ATM function keys to make menu selections or product decisions, in a manner similar to that used with conventional ATMs. In order to guide the customer, there are typically up to eight of these Function Key Labels that correspond to each of the ATM's function keys. As with traditional BASE24, the positioning of the Function Key Labels is based on the ATM screen type. These Labels provide the “meaning” of each specific function key. The content of the Function Key Labels could change with each interaction with the customer.

In a preferred embodiment, the customer receipt can be divided into zones suitable for placing advertisement content. This area is called the Receipt Ad. Such zones might include, for example, the top, bottom, sides or back of the receipt.

Transaction and Screen Flows

The following tables 1-11 depict representative samples of Web ATM screen flows according to the present invention. Although the examples depicted in the tables are in English, Web ATMs can support screen dialog and advertisements in the customer's language of choice. The Screen Name column lists the major screens and the name by which they are referred. The Screen Dialog column lists the fixed text (prompts related to an ATM transaction and not to an advertisement), that will be displayed on the screen. The Processing column describes the relevant processing that occurs while at the screen. The Available Ad Type column lists what types of ads may play while the screen is displayed. The Function Key column lists the active function keys for the screen.

As used herein, the term “Sponsored,” when used to refer to an ATM user or an ATM access or debit card, means the ATM user is a customer of the bank, financial institution, or the entity that owns or provides the ATM. The term “Acquired,” when used to refer to an ATM user or an ATM access or debit card, means the ATM user is not a customer of the bank, financial institution, or other entity that owns or provides the ATM.

In general, the same Main ad will play throughout an entire transaction, without interruption for errors or exceptions. All the various error and exception screens (i.e., “Do you need more time for this transaction?”) will continue to display the same Main ad as was on the transaction screen where the exception or error occurred. When the transaction is finished, the ad will end. If the customer starts a new transaction, the same Main ad will start again from the top, or, if another ad was defined for this campaign, the next Main ad in the list will start.

TABLE 1
Initial and Closing Customer Flows

| Screen Name | Screen Dialog | Processing | Available Ad Type | Function Key |
|---|---|---|---|---|
| Attract | | Set default background | Teaser | |
| | | (no audio here) | Attract | |
| Welcome | Please insert your card | If Sponsored, get customer | Teaser | |
| | | information from BOSS | Attract | |
| Language/PIN | Enter PIN (ID Code) | | Teaser | C-Press this key (English) |
| | then press this key | | | D-Oprima Aqui (Spanish) |
| | Despues de Marcar Su | | | |
| | Pin Oprima Aqui | | | |
| Take Your Card | Thank you, please take | Return card to customer/ | Teaser | |
| | your card | beep and an audio Thank You | Closer | |

TABLE 2
Sponsored Menus

| Main Menus Screen Name | Screen Dialog | Processing | Available Ad Type | Function Key |
|---|---|---|---|---|
| Acquirer Main Transaction | Press function key to | Used for non-Sponsored | Targeted | I-Additional Services |
| Menu | select transaction | debit cards and credit | Teaser | A-Fash Cash |
| | | cards | | B-Withdrawal |
| | | Begin to customize | | C-Balance Inquiry |
| | | screens based on bin- | | D-Transfer |
| | | determine whether targeted | | |
| | | acquirer or basic acquirer | | |
| | | Branch to select financial | | |
| | | transaction flow | | |
| Sponsored Main Transaction | Press function key to | Used for Sponsored debit | Targeted | F-Deposit |
| Menu, Page 1 | select transaction | cards | Teaser | G-Payment |
| | | Begin to customize | | H-Statement |
| | | screens based on Customer | | I-Additional Services |
| | | Profile info returned from | | A-Fash Cash |
| | | BOSS-i.e., use customer's | | B-Withdrawal |
| | | name, set background based | | C-Balance Inquiry |
| | | on Customer Segment, etc. | | D-Transfer |
| | | If Additional Services | | |
| | | display Sponsored Main | | |
| | | Tranaction Menu, Page 2 | | |
| | | All other selections, | | |
| | | branch to selected financial | | |
| | | transaction flow | | |
| Sponsored Main Transaction | Press function key to | Used for Sponsored debit | Targeted | F-Check Reorder or Message |
| Menu, Page 2 | select transaction | cards | Teaser | G-Mortgage Information |
| | | If request for Check | | H-Investment Information |
| | | Reorder (F) then branch | | I-Earn $5, Banking Survey |
| | | to the “Check Reorder” | | B-Return to Main Menu |
| | | transaction flow | | |
| | | If request for product | | |
| | | information (G, H, or I) | | |
| | | then display the “How | | |
| | | May We Contact” screen | | |
| | | If Return to Main Menu (B) | | |
| | | then display Sponsored Main | | |
| | | Transaction Menu, Page 1. | | |

TABLE 3
Fast Cash (Sponsored)

| Screen Name | Screen Dialog | Processing | Available Ad Type | Function Key |
|---|---|---|---|---|
| Select Amount | Select Amount | Format request for | Targeted | G-$20 |
| | | PIN validation and | Teaser | H-$40 |
| | | financial transaction | | I-Return to Main Screen |
| | | | | B-$60 |
| | | | | C-$100 |
| Wait for processing | | | Targeted | |
| | | | Teaser | |
| Take Cash | Please take your cash | Eject card and display | Targeted | |
| | from the dispenser | “Closer” screen | Teaser | |
| | | | Receipt | |

TABLE 4
Cash Withdrawal (Sponsored)

| Screen Name | Screen Dialog | Processing | Available Ad Type | Function Key |
|---|---|---|---|---|
| Enter Amount | Enter amount for | | Targeted | A-Correct |
| | the transaction | | Teaser | B-Change |
| Select From Account | Press function key to | Format request for | Targeted | G-Credit |
| Type | select from account type | PIN validation and | Teaser | H-Line of Credit |
| | | financial transaction | | I-Return to Main Menu |
| | | | | B-Checking |
| | | | | C-Savings/Money Market |
| Wait for processing | | | Targeted | |
| | | | Teaser | |
| Which Account | Press function key to | Format request for | Targeted | A-D contain a list of accounts |
| (OAR only) | select the account | financial transaction | Teaser | |
| Wait for processing | | | Targeted | |
| (OAR only) | | | Teaser | |
| Take Cash | Please take your cash | | Targeted | |
| | from the dispenser | | Teaser | |
| | | | Receipt | |
| Sponsored-Another | Would you like another | If dialog ending (NO) | Targeted | F-Check Reorder or Message |
| Transaction | transaction? | display “Closer” screen | Teaser | G-Mortgage Information |
| | | If request for another | | H-Investment Information |
| | | transaction (YES) then | | I-Earn $5, Banking Survey |
| | | display Sponsored Main | | B-Yes |
| | | Transaction Menu | | C-No |
| | | If request for Check | | |
| | | Reorder then branch to | | |
| | | the “Check Reorder” | | |
| | | transaction flow | | |
| | | If request for product | | |
| | | information (G, H, or I) | | |
| | | then display the “How | | |
| | | May We Contact” screen | | |

TABLE 5
Cash Withdrawal (Acquirer)

| Screen Name | Screen Dialog | Processing | Available Ad Type | Function Key |
|---|---|---|---|---|
| Enter Amount | Enter amount for | | Targeted | A-Correct |
| | the transaction | | Teaser | B-Change |
| Select From Account | Press function key to | Format request for | Targeted | I-Return to Main Menu |
| Type | select from account type | PIN validation and | Teaser | B-Checking |
| | | financial transaction | | C-Savings/Money Market |
| Wait for processing | | | Targeted | |
| | | | Teaser | |
| Take Cash | Please take your cash | | Targeted | |
| | from the dispenser | | Teaser | |
| | | | Receipt | |
| Acquirer-Another | Would you like another | If dialog ending (NO) | Targeted | G-Mortgage Information |
| Transaction | transaction? | display “Closer” screen | Teaser | H-Investment Information |
| | | If request for another | | I-Earn $5, Banking Survey |
| | | transaction (YES) then | | B-Yes |
| | | display Acquirer Main | | C-No |
| | | Transaction Menu | | |

TABLE 6
Deposit (Sponsored)

| Screen Name | Screen Dialog | Processing | Available Ad Type | Function Key |
|---|---|---|---|---|
| | Enter amount for | | Targeted | A-Correct |
| | the transaction | | Teaser | B-Change |
| Deposit Into Account | Press function key to | Format request for | Targeted | I-Retun to Main Menu |
| Type | select Deposit account | PIN validation and | Teaser | B-Checking |
| | type | financial transaction | | C-Savings/Money Market |
| Wait for processing | | | Targeted | |
| | | | Teaser | |
| Which Account | Press function key to | Format request for | Targeted | A-D contains a list of accounts |
| (OAR only) | select the account | financial transaction | Teaser | |
| Wait for processing | | | Targeted | |
| (OAR only) | | | Teaser | |
| Insert Envelope | Insert your sealed | | Targeted | |
| | envelope into depository | | Teaser | |
| | | | Receipt | |
| Sponsored-Another | Would you like another | If dialog ending (NO) | Targeted | F-Check Reorder or Message |
| Transaction | transaction? | display “Closer” screen | Teaser | G-Mortgage Information |
| | | If request for another | | H-Investment Information |
| | | transaction (YES) then | | I-Earn $5, Banking Survey |
| | | display Sponsored Main | | B-Yes |
| | | Transaction Menu | | C-No |
| | | If request for Check | | |
| | | Reorder then branch to | | |
| | | the “Check Reorder” | | |
| | | transaction flow | | |
| | | If request for product | | |
| | | information (G, H, or I) | | |
| | | then display the “How | | |
| | | May We Contact” screen | | |

TABLE 7
Payment (Sponsored)

| Screen Name | Screen Dialog | Processing | Available Ad Type | Function Key |
|---|---|---|---|---|
| Enter Amount | Enter amount for | | Targeted | A-Correct |
| | the transaction | | Teaser | B-Change |
| Select Payment Method | Press function key to | Format request for | Targeted | I-Return to Main Menu |
| | select payment method | PIN validation and | Teaser | A-Enclose Cash or Check with |
| | | financial transaction | | Payment Coupon in envelope |
| | | | | B-Payment to Line of Credit |
| | | | | from Checking |
| | | | | C-Payment to Line of Credit |
| | | | | from Savings |
| Wait for processing | | | Targeted | |
| | | | Teaser | |
| Which Account | Press function key to | Format request for | Targeted | A-D contains a list of accounts |
| (OAR only) | select the account | financial transaction | Teaser | |
| Wait for processing | | | Targeted | |
| (OAR only) | | | Teaser | |
| Insert Envelope | Insert your sealed | | Targeted | |
| | envelope into depository | | Teaser | |
| | | | Receipt | |
| Sponsored-Another | Would you like another | If dialog ending (NO) | Targeted | F-Check Reorder or Message |
| Transaction | transaction? | display “Closer” screen | Teaser | G-Mortgage Information |
| | | If request for another | | H-Investment Information |
| | | transaction (YES) then | | I-Earn $5, Banking Survey |
| | | display Sponsored Main | | B-Yes |
| | | Transaction Menu | | C-No |
| | | If request for Check | | |
| | | Reorder then branch to | | |
| | | the “Check Reorder” | | |
| | | transaction flow | | |
| | | If request for product | | |
| | | information (G, H, or I) | | |
| | | then display the “How | | |
| | | May We Contact” screen | | |

TABLE 8
Transfer (Sponsored)

| Screen Name | Screen Dialog | Processing | Available Ad Type | Function Key |
|---|---|---|---|---|
| | Enter amount to | | Targeted | A-Correct |
| | transfer | | Teaser | B-Change |
| Select From Account | Press function key to | Format request for | Targeted | G-Credit |
| Type | select from account | PIN validation and | Teaser | H-Line of Credit |
| | type | financial transaction | | I-Return to Main Menu |
| | | | | B-Checking |
| | | | | C-Savings/Money Market |
| Select To Account | Press function key to | Format request for | Targeted | I-Return to Main Menu |
| Type | select to account type | PIN validation and | Teaser | A-Checking |
| | | financial transaction | | B-Savings/Money Market |
| Wait for processing | | Start print receipt | Targeted | |
| | | if not OAR | Teaser | |
| | | | Receipt | |
| Which Account | Press function key to | Format request for | Targeted | A-D contains a list of accounts |
| (OAR only) | select the accounts | financial transaction | Teaser | |
| | from and to | | | |
| Wait for processing | | | Targeted | |
| (OAR only) | | | Teaser | |
| | | | Receipt | |
| Sponsored-Another | Would you like another | If dialog ending (NO) | Targeted | F-Check Reorder or Message |
| Transaction | transaction? | display “Closer” screen | Teaser | G-Mortgage Information |
| | | If request for another | | H-Investment Information |
| | | transaction (YES) then | | I-Earn $5, Banking Survey |
| | | display Sponsored Main | | B-Yes |
| | | Transaction Menu | | C-No |
| | | If request for Check | | |
| | | Reorder then branch to | | |
| | | the “Check Reorder” | | |
| | | transaction flow | | |
| | | If request for product | | |
| | | information (G, H, or I) | | |
| | | then display the “How | | |
| | | May We Contact” screen | | |

TABLE 9
Check Re-order/Message (Sponsored)

| Screen Name | Screen Dialog | Processing | Available Ad Type | Function Key |
|---|---|---|---|---|
| Check re-order/Msg | Press function key to | Format request for | Targeted | A-Press if Correct |
| | confirm either a check | PIN validation and | Teaser | B-Return to Main Menu |
| | re-order or a message | financial transaction | | |
| | is enclosed in envelope | | | |
| Wait for processing | | | Targeted | |
| | | | Teaser | |
| Insert Envelope | Insert your sealed | | Targeted | |
| | envelope into depository | | Teaser | |
| | | | Receipt | |
| Sponsored-Another | Would you like another | If dialog ending (NO) | Targeted | F-Check Reorder or Message |
| Transaction | transaction? | display “Closer” screen | Teaser | G-Mortgage Information |
| | | If request for another | | H-Investment Information |
| | | transaction (YES) then | | I-Earn $5, Banking Survey |
| | | display Sponsored Main | | B-Yes |
| | | Transaction Menu | | C-No |
| | | If request for Check | | |
| | | Reorder then branch to | | |
| | | the “Check Reorder” | | |
| | | transaction flow | | |
| | | If request for product | | |
| | | information (G, H, or I) | | |
| | | then display the “How | | |
| | | May We Contact” screen | | |

TABLE 10
Sponsored Request for Product Information

| Screen Name | Screen Dialog | Processing | Available Ad Type | Function Key |
|---|---|---|---|---|
| Sponsored-Another | Would you like another | If request for product | Targeted | F-Check Reorder or Message |
| Transaction | transaction? | information (G, H, or I) | Teaser | G-Mortgage Information |
| | | then display “How | | H-Investment Information |
| | | May We Contact” screen | | I-Earn $5, Banking Survey |
| | | | | B-Yes |
| | | | | C-No |
| How May We Contact | How May We Contact | Format and e-mail the | Targeted | F-By E-mail |
| (Sponsored only) | you? | How May We Contact | Teaser | G-By Phone |
| | | request to the appropriate | Receipt | H-By U.S. Mail |
| | | bank employee; include | | I-Banking Center Appt |
| | | the customer's preferred | | B-Return to Main Menu |
| | | contact method (E-mail, | | |
| | | Phone, Mail or Banking | | |
| | | Center Appt) and customer | | |
| | | profile information in | | |
| | | the Lotus Note | | |
| | | Format and print receipt | | |
| | | related to topic of info | | |
| | | request | | |
| Confirm request and | We will contact you | Customized contact dialog | Targeted | F-Check Reorder or Message |
| Another Transaction | “today” via “e-mail” | based upon time of day | Teaser | G-Mortgage Information |
| | Would you like another | and contact method chosen | | H-Investment Information |
| | transaction? | If dialog ending (NO), | | I-Earn $5, Banking Survey |
| | | display “Closer” screen | | B-Yes |
| | | If request for another | | C-No |
| | | transaction (YES) then | | |
| | | display Sponsored Main | | |
| | | Transaction Menu | | |
| | | If request for Check | | |
| | | Reorder then branch to | | |
| | | the “Check Reorder” | | |
| | | transaction flow | | |
| | | If request for product | | |
| | | information (G, H, or I) | | |
| | | then display the “How | | |
| | | May We Contact” screen | | |

TABLE 11
Acquirer Request for Product Information

| Screen Name | Screen Dialog | Processing | Available Ad Type | Function Key |
|---|---|---|---|---|
| Acquirer-Another | Would you like another | If request for product | Targeted | G-Mortgage Information |
| Transaction | transaction? | information (G, H, or I) | Teaser | H-Investment Information |
| | | then display “Phone | | I-Earn $5, Banking Survey |
| | | Number Entry” screen | | B-Yes |
| | | | | C-No |
| Phone Number Entry | Please enter your | Format and e-mail the | Targeted | A-Correct |
| | telephone number. | acquirer customer's name | Teaser | B-Change |
| | | bank and phone number | Receipt | I-Return to Main Menu |
| | | to the appropriate bank | | |
| | | employee | | |
| | | Format and print receipt | | |
| | | related to topic of the | | |
| | | info request | | |
| Another Transaction | Would you like another | Customized contact dialog | Targeted | G-Mortgage Information |
| | transaction? | based upon time of day | Teaser | H-Investment Information |
| | | and contact method chosen | | I-Earn $5, Banking Survey |
| | | If dialog ending (NO), | | B-Yes |
| | | display “Closer” screen | | C-No |
| | | If request for another | | |
| | | transaction (YES) then | | |
| | | display Sponsored Main | | |
| | | Transaction Menu | | |
| | | If request for Check | | |
| | | Reorder then branch to | | |
| | | the “Check Reorder” | | |
| | | transaction flow | | |
| | | If request for product | | |
| | | information (G, H, or I) | | |
| | | then branch to the “How | | |
| | | May We Contact” screen | | |

Configuring Web ATM Ads

In one embodiment, the advertising content presented on the Web ATM is specified at three different levels:

Session Based—different ad content can be configured depending on whether or not the ATM is in use;

Customer Based—different ad content can be configured for different customer types; and

Rules Based—overrides can be defined to alter the particular ad selection during a session.

A discussion of how the administrator configures and coordinates the advertising material for the optimal customer experience is now provided. In a preferred embodiment, several profiles may be defined:

The Campaign Profile defines the attributes of a marketing campaign;

The Ad Profile defines the attributes and relationships of specific graphics files;

The ATM Profile defines the attributes of specific ATMs;

The Customer Profile defines customer types to the system; and

The User Supplied Profile Files define card numbers or prefixes for specific market segments of customers.

In a preferred embodiment, the Customer Profile contains references (links) to certain ads, which establish the relationship between specific customer types and session-based advertising content. Likewise, the ATM Profile may contain references to certain ads, which establishes the relationship between specific ATMs and non-session based advertising content.

1. Campaign Profile Definition

A marketing campaign is the term used to describe a set of advertising content that has been targeted to a specific group of customers. A campaign can reference all types of ads.

The fields used in a campaign definition are:

Campaign Name—the name provided by the advertiser for this campaign;

Description—text that describes this campaign;

Effective Start—the date/time that the campaign should be used in production;

Effective End—the date/time that the campaign should not be used in production;

Relative Priority—the priority this campaign has relative to other active campaigns. This element is used when multiple campaigns are active and the customer or when the Web ATM qualifies for more than one campaign.

2. Ad Profile Definition

An ad refers to any advertising content that will be presented to the customer. In a preferred embodiment, the fields used in an ad profile definition are:

Ad Name—the name provided by the advertiser for this ad;

Ad Description—text that describes the ad such as content, play time, etc.;

AdType—the type of ad. Types may be defined, for example, as Background, Attract, Targeted, Closer or Teaser.

Campaign Associations—name(s) of the campaign(s) with which this ad should be associated. An ad can belong to one or many different campaigns. The system provides a list box of all active or future campaigns.

Product Categories—the name(s) of the products with which this ad should be associated. An ad can be associated with none or many different products. This element is used in exclusion processing.

File Name—the name of the file containing the ad content

3. Customer Profile Definition

Customer or user profiles provide a way to categorize Web ATM users. In a preferred embodiment, the system provides an initial set of customer profiles that correspond to the different customer segment values. The administrator may also define special customer profiles by either providing a file containing specific card numbers or by providing a file containing card number prefixes. Preferably, the Customer Profile contains the following fields:

Customer Profile ID—the name of this customer profile. The system will provide several standard customer profiles;

Profile Type—defines the processing used by the system. Values are:

None—used when there is no customer;

Sponsored Default—used when customer information is unavailable;

Acquired Default—used for competitors' customers;

Customer Segment—the market segment for the customer;

Market Set—use the Web ATM database of card numbers;

Card Prefix—use the acquired customer card prefix database.

4. Advertiser-Supplied Customer Lists

The “advertiser” may be a party or organization that is internal or external to the bank, financial institution or other entity that owns or provides the ATM. As stated above, access card numbers or card prefixes can be loaded into the Web ATM database. In the preferred embodiment, the Advertiser-Supplied Customer Lists could be populated with records containing the following data elements:

Card Number or Prefix—the card number or card prefix containing up to 16 numeric characters. In one embodiment of the present invention, acceptable wild cards are “%” for any number of characters or “#” for single character substitution;

Customer profile ID—the user defined customer profile value that matches one defined within the Web ATM customer profile database;

Customer Message—advertiser-selected text message to be displayed to the ATM user.

Effective Start Date—the date when the system should use this entry;

Effective Stop Date—the expiration date of this entry—i.e., when it should be removed from the database.

5. Linking Ads to Customer Profiles

Once the Ads and the Customer Profiles have been defined to the system, an administrator can then make the association between the ad and the customer profile. This is the mechanism to define which ads play during a customer session. The administrator first selects the particular customer profile. Next the campaign is selected. Finally, the linkages between a specific customer profile and a specific ad are made. The administrator may select multiple ads for a particular customer profile, but if there are multiples, then the administrator should set the relative priority. In a preferred embodiment, the fields used on this form are:

Customer Profile ID—the value of a defined customer profile. The system provides a list box of all customer profiles for the advertiser to select. Multiple customer profiles may be selected;

Campaign—the value of a defined campaign. The system provides a list box of the valid (i.e., non-expired) campaigns for the user to select. Multiple campaigns can be selected;

Ad Type—the type (e.g. background, targeted, teaser) of the ad. Preferably, this is a protected field;

Ad ID—the ID of the Ad that the user wants to link to this set of customer profiles; and

Relative Priority—the order this ad should play relative to other ads defined for this customer profile and ad type.

6. Linking Ads to Market Classes

“Attract” or “Teaser” ads are ads that play when there is no customer session in progress. The process used for linking customers to ads may also be used to define Attract and Teaser ads. When ATMs are added to the system, they are also a given “market class.” The market class provides a way to specify that the ATM has specific business arrangement (e.g., in a store, such as Safeway), has a specific location (e.g., Bay Area), has a specific capability (e.g., Web ATM), or any combination of the three. Market class can be used to determine the set of graphics that the ATM will receive. Additionally, with the Web ATM, the market class specifies the ads that will play when there is no customer session in progress.

To define the ad association, the administrator may link the market class to the Customer Profile. Since the customer profile contains a link to certain ads, the system can then associate certain ads to certain market classes. Alternatively, an ATM profile could be used to link certain ads to certain ATMs.

Table 12 below depicts the advertising components that can be built based upon the Customer Profile.

TABLE 12
Advertising Components

| | | | |
|---|---|---|---|
| Non-Specific | Attract | Banking Center Ad | Background |
| | Teaser | Teaser | |
| Sponsored Default | | | |
| Basic | Targeted | Target | Background1 |
| Plus | Closer | Closer | |
| Associates | | | |
| Premier | Targeted | Target2 | Background2 |
| Private | Teaser | Teaser2 | |
| | Closer | Closer2 | |
| Targeted Acquirer | Targeted | Target3 | Background1 |
| | Closer | Closer2 | |
| Acquirer Default | Targeted | Target4 | Background1 |
| | Teaser | Teaser3 | |
| | Closer | Closer1 | |

Web ATM AD Selection Process

A Web ATM, according to one embodiment of the present invention, has two types of advertising “personalities” depending whether or not there is a customer session. When there is no card inserted into the Web ATM, the Web ATM is in “Out-of-Session” processing mode. In Out-of-Session processing mode, the Web ATM's personality is defined by its “market class.” The market class personality defines the specific content of the Background and Main Ad visual zones. For example, the Background content could be a co-branded look when the ATM is in-store. The Attract Ad in the Main Ad zone could be playing a regionally targeted ad that varies depending on geography. The ATM administrators have the ability to configure the market class of the ATM and its relationships to advertising content.

Out-Of-Session Processing Mode

After a Web ATM is brought up, it queries the Web Server. The Web server will:

Retrieve the Market Class of the ATM;

Use the Market Class to obtain the name of an ad that has an Out-of-Session ad;

Serve up the graphics file that is specified by that ad name;

Use the Market Class to obtain the name of another ad that has an Out-of-Session ad type;

Serve up the graphics file that is specified by that ad name;

Use the Market Class to obtain yet another name of an ad that has an Out-of-Session ad type; and

Serve up the graphics file that is specified by that ad name.

The Out-of-Session ad types continue to play on the Web ATM until a customer inserts his/her card. Whenever the customer session is over (i.e., the card is removed), the Web ATM will begin to play the ad types again. If more than one ad satisfies any of the retrievals, the Web Server invokes override processing (described below). If no ad is specified, the default market class may be used. These ads will play until a customer session is started.

In the preferred embodiment, any number of different Out-of-Session or In-Session ad types could be defined depending, for example, on the number of screen zones desired. Such ad types might include, for example, Attract (no customer session in progress), CheckCard (product screens for a check card), Home Equity (product screens for home equity loans), Messages (screens for sending messages to or from the owner or provider of the ATM), User Pref (for helping users set up personal preferences), Generic (for in-store or location specific product promotions), Out-of-Service (for displaying out of service messages), PinEntry (for display while the ATM waits for PIN entry), Profile Wait (for display while a user profile is being fetched from the network), Thank You (for display at the end of a customer session), etc.

In a preferred embodiment, any number of “Show Ad Types” may be defined, such as: Opener (for display when a user inserts an access or debit card), Opener Action (same as Opener, but with a “call to action” button or control that allows the user to respond or request additional information immediately), Main (ads that play during the main part of a user session), Closer (ads that play at the close of a user session) and Closer Action (ads that play at the close of a user session with a “call to action” control).

Customer Ad Selection Process

The ad a customer views at any particular time is based on a variety of factors. When a customer inserts their card into the ATM, that card number is sent to the Web Server for processing. The Web Server selects a set of ads whose order of play is based on a dynamic, relative weight assigned to each of the ads. The goals of this Ad Selection algorithm are:

Play ads that are targeted to the customer;

Play ads that are targeted to the location;

Play some ads more often than others; and

Play a variety of ads to avoid playing the same ad for the same customer during each transaction.

In one embodiment, three components are used in selecting the set of ads for a particular customer: the customer access card, the customer profile and the ATM location. One of skill in the art would recognize and appreciate, however, that a fewer or greater number of components, or different components, could be used to select ads without departing from the scope of the invention.

In a preferred embodiment, the system associates ads with particular card numbers or card prefixes. This facility can be used to support targeted marketing to a particular customer. If the bank has a customer who is a prime candidate for a specific product, a particular ad for that product is associated with that particular card number. The system searches the database for occurrences of that card number and retrieves any ads associated with it using a linking element called a card profile. Similarly, a portion of the card number, or the card prefix, can be associated with a particular ad. For example, if it is known that a competitor uses card prefix 123456, certain ads in the database can be associated with that card prefix. Thus, certain ads will be retrieved whenever a customer of that competitor uses an ATM with that card.

In a preferred embodiment, a customer profile is assigned to each customer based on that customer's relationship with the bank. With the card number, the system can retrieve a specific cardholder's customer profile. As with the card number, a customer profile can be linked with a specific ad that is targeted for all customers that have that profile.

Each ATM location is assigned a market class. This value acts much like a profile for an ATM. The market class specifies any aspect of ATM presence, such as the category, the business usage, and the geography of the ATM. For example, a branded ATM in a Georgia supermarket could have one market class while an ATM in a Georgia banking center could have another. Ads are associated in the Web Server database with specific market classes. This allows the present invention to target ATM locations as closely as it targets customers.

The Web Server uses the combination of the customer card number and an ATM identification number to retrieve card-based profiles, customer-based profiles, and ATM-based profiles. With this list of profiles, the server retrieves the list of ads that have been associated with those profiles to produce the complete set of ads for that customer session.

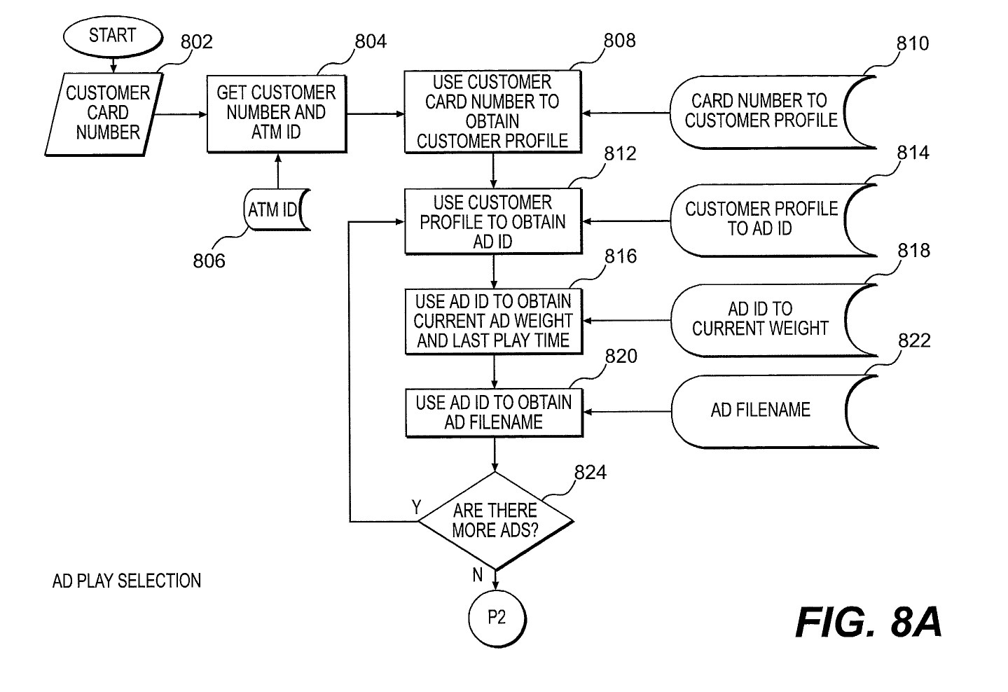

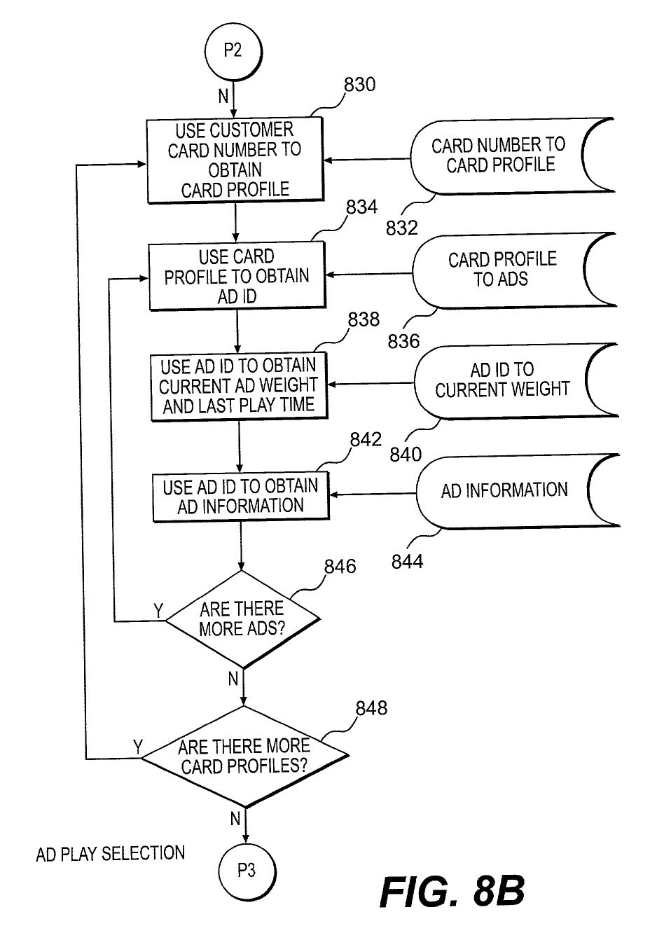

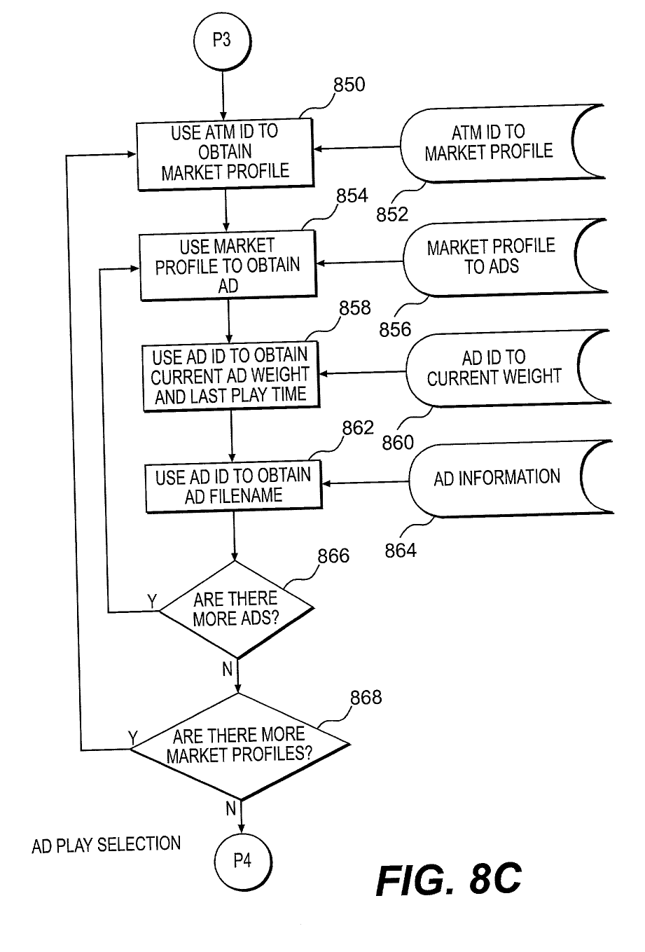

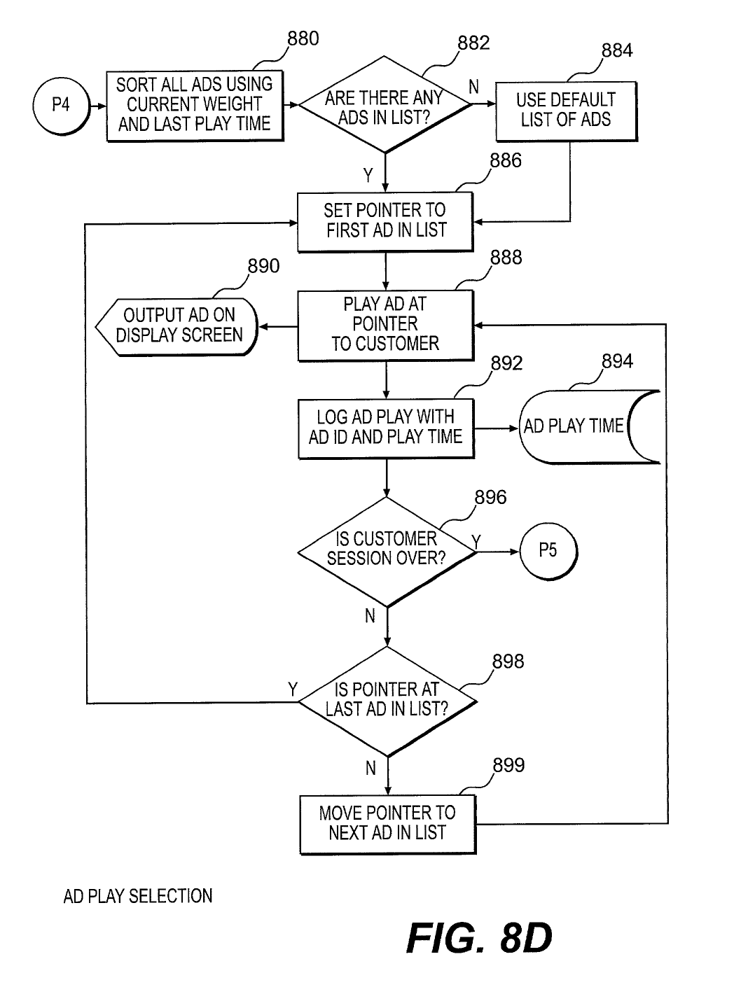

FIGS. 8A, 8B, 8C and 8D depict the flow diagram for one example of an algorithm which could be used to select, order and play ads in one embodiment of the present invention. When a user inserts an access card into a Web ATM, step 802, Web ATM records the access card number and the ATM ID, steps 804 and 806. Next, in a step 808, the customer card number is used to obtain a customer profile value from a file linking card numbers to customer profiles, 810. The customer profile value is used to obtain an ad ID, step 812, from a file linking customer profiles to ad ID values (814). The system uses the Ad ID to retrieve the weights and last play time (step 816) for the ads based on references in a file (818) that contain links between ads and assigned weights. Then, in step 820, the Ad ID is used to obtain the filename for the ad from an ad filename file 822. Next, in a step 824, the system checks to see whether there were any more ads for this customer profile. If there is, then processing returns to step 812. If there are no more ads associated with the customer profile, then processing proceeds to FIG. 8B via connector P2.

Referring to FIG. 8B, the customer card number (already retrieved in step 804, above) is used in a step 830 to obtain a card profile number from a file 832 that links card numbers to card profiles. Once the card profile number is obtained, it is used in step 834 to obtain an ad ID from a file 836 linking card profile numbers to Ad Ids. The ad ID is then used in step 838 to find the weight assigned to that ad (and last play time) in a file 840 linking Ad ID's to a current weight. The ad ID is also used, in step 842, to obtain an ad filename from input file 844. Next, the system checks to see if any more ads are associated with this card profile, step 846. If the answer is yes, then processing returns to step 834 where the card profile is used to obtain the next ad. If there are no more ads associated with this card profile, the system determines whether there are any more card profiles associated with this card number, step 848. If the answer is yes, processing returns to step 830, where the card number is used to retrieve the next card profile. If there are no more card profiles, associated with the card number, then processing continues to the flow diagram depicted in FIG. 8C via flow diagram connector P3.

Turning now to FIG. 8C, the system uses the ATM ID (already obtained in step 804, discussed above) to obtain a market profile for the ATM, step 850, by checking a file 852 containing a link between ATM Ids and market profiles. The market profile is used to obtain an Ad associated with the market profile, step 854 by checking file 856, which contains a logical link between market profiles and ATM Ids. Next, in a step 858, the ad ID is used to obtain a current weight (and lost play time) for the add by checking a file 860 containing a weight value for each ad. Then the Ad ID is used to obtain the ad filename in a step 862, by retrieving the ad filename from input file 864. The system then checks, in step 866, whether there are any more ads associated with this market profile. If the answer is yes, then processing returns to step 854, where the market profile is used to retrieve the next ad. If there are no more ads associated with this particular market profile, then the system checks to see whether there is another market profile associated with this ATM ID, step 868. If the answer is yes, then processing returns to step 850, where the ATM ID is used to obtain the next market profile. If there are no more market profiles associated with this ATM ID, then processing continues in the diagram depicted in FIG. 8D via flow connector P4.

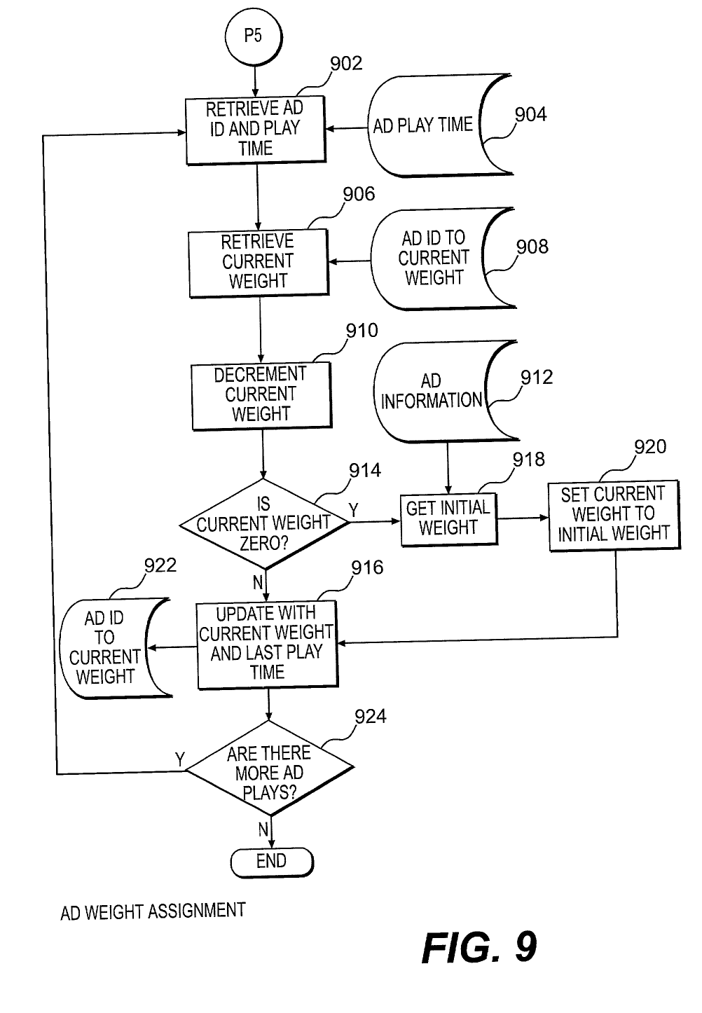

As shown in FIG. 8D, all ads may be sorted based on the current weight (and/or last play time), illustrated at step 880. In a step 882, the system looks to see if, after all the sorting and weighting, any ads remain in the list. If there are no Ads in the list, then the processor uses the default list of ads retrieved from file 884. If there are ads in the list, a pointer is set to the first ad, step 886. Then, in step 888, the ad at the pointer is displayed on output screen 890, and the system records the Ad ID and the time at which the ad played, step 892, in file 894. Next, the system checks to see whether the customer session is over, step 896. If the customer session is over, processing continues according to the flow diagram contained in FIG. 9 via flow connector P5. If the customer session is not over, then the systems checks to see if the pointer is at the last ad in the list, step 898. If so, then the pointer is reset to the first ad in the list, step 886, and the list of ads will start to play over again. If the pointer is not at the last ad in the list, then the pointer is moved to the next ad, step 899, and processing continues at step 888, where the play at the pointer is displayed to the user via output display 890. Weight Assignments The weights which determine the play order of ads can be assigned to the ads in any number of different ways. Each combination of profile and ad is given a user-assigned weight. For example, an ad for a credit card product could be assigned a weight of 90 for a particular card-number profile. That same ad might be assigned a weight of 50 when it is combined with a particular customer profile. Finally, that same ad might be assigned a weight of 10 when it is associated with a particular market class profile.

In a preferred embodiment, two weights are used by the Web Server. The assigned weight was discussed above with reference to FIGS. 8A-8D. This assigned weight changes only when an administrator wants to re-adjust the profile-to-ad weights. A second weight value, the current weight, is initialized with the value of assigned weight. Each time that ad is played for that particular profile-ad combination, the current weight is decremented. When the current weight arrives at zero, it is reinitialized to the assigned weight by the Web Server. Alternatively, weight could be incremented each time an ad is played to reach a ceiling value before it is reinitialized by the web server.

When the ad list is retrieved, the Web Server also retrieves the current weight for each profile-ad combination. It then orders the list of ads for this customer session based on the weight value. Higher weight value ads play before lower weight value ads. If the same ad is retrieved for multiple profiles, that ad will appear multiple times in the list. Alternatively, the system can be configured to avoid putting the same ad in a playlist more than once.

After each customer session is complete, a play log for that customer session is sent to the Web Server. The Web Server uses this play log to decrement the current weight on profile-ad combinations that were seen by that customer. If the customer did not view the ad, the current weight is not decremented.

Although other algorithms may be used without departing from the scope of the present invention, this algorithm provides the following benefits:

Ads targeted for different profiles will always be delivered to the Web-enabled ATM based on the specific customer/ATM session;

The frequency of ad play in general is based on relative weights of a given population of profile-ad combinations; and

Any particular play list order is dynamic based on the frequency of viewing by the targeted customer set and the current weight of the ad relative to all other ads in the set.

FIG. 9 depicts a flow diagram for one example of an algorithm which could be used to set the weights of selected ads. First, an ad ID and last playtime for the ad is retrieved, step 902, from input file 904. Then the current weight value is retrieved, step 906, from input file 908. Next, the current weight is decremented, step 910, and the system checks whether the current weight is equal to zero, step 914. If the current weight is not equal to zero, the system updates the current weight file 922 with current weight and last play time (see step 916). If the current weight is equal to zero, then the system retrieves the initial weight, step 918, from an ad information file 912, and resets the current weight of the ad to its initial weight, step 920, before updating the current weight file 922 in step 916. Next, the system checks whether any other ads have been played, step 924. If not, then processing ends. Otherwise, processing returns to step 902, where the ad ID and play time for played ads is retrieved.

Overrides

In a preferred embodiment, there are several different ways a defined advertising selection can be altered dynamically. The system may be configured so that these alternatives only go into effect when there are multiple ads defined for a particular customer profile.

Priority—When an Ad is defined for a customer or customer segment, it also has a relative priority. This priority is used to determine which ad will play.

Exclusion—Ads may have assigned product attributes. For example, a Gold Visag ad may be assigned the Visa product attribute. The customer product set will be evaluated and any ads that have the same product attribute as the customer will be excluded from play.

History—If there are multiple ads defined for this customer, the system may be configured to check a history file and play the least viewed ad based on priority.

Quick Transactions

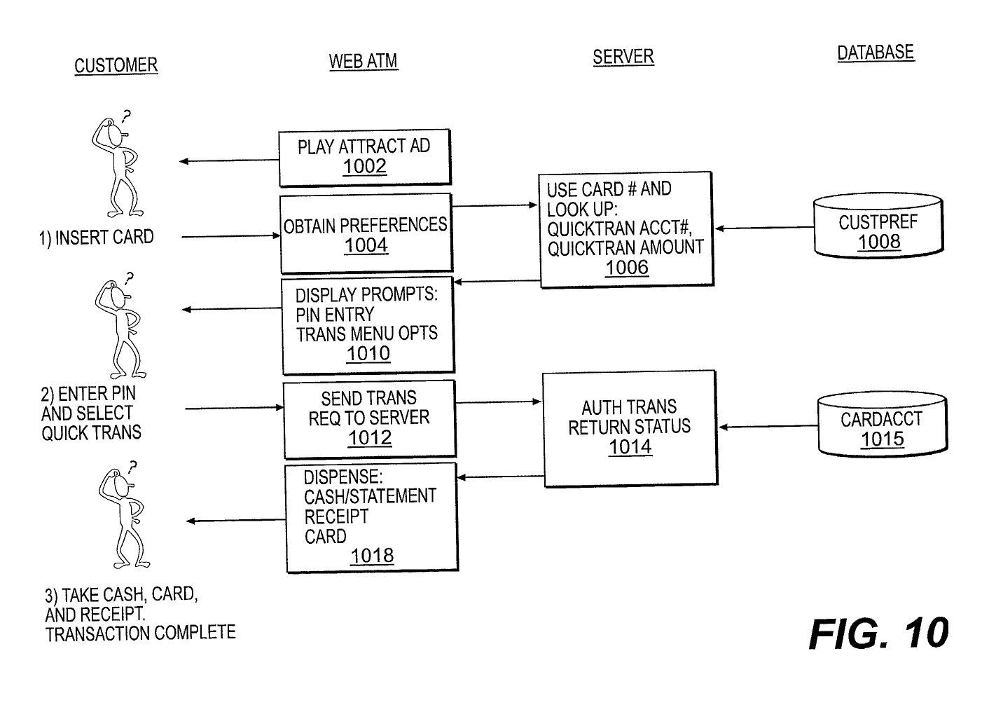

FIG. 10 illustrates the general data flow of a “quick transaction” conducted in accordance with one embodiment of the present invention. First, as illustrated by step 1002, an Attract Ad is played on Web ATM 110 whenever there is no user session in progress. When a user inserts an access (or debit) card, the user's preferences are obtained (step 1004). In the preferred embodiment the preferences are obtained by using the card number to retrieve the user's quick transaction account number and amount, step 1006, from a customer preference file, 1008. Next, the system displays a prompt for the user to enter a personal identification number (PIN) and select a transaction account, step 1010. After the user responds to the PIN entry and transaction account prompt, a transaction request is sent (step 1012) to the Host Mainframe Server (depicted in FIG. 1 with reference number 150), which looks up the account based on the card number in a card account database (1015), and sends a return status back to Web ATM 110. If the transaction is approved at step 1014, then the system completes the transaction in step 1018 by dispensing cash, the access card and, if the user preferences are set to do so, a receipt.

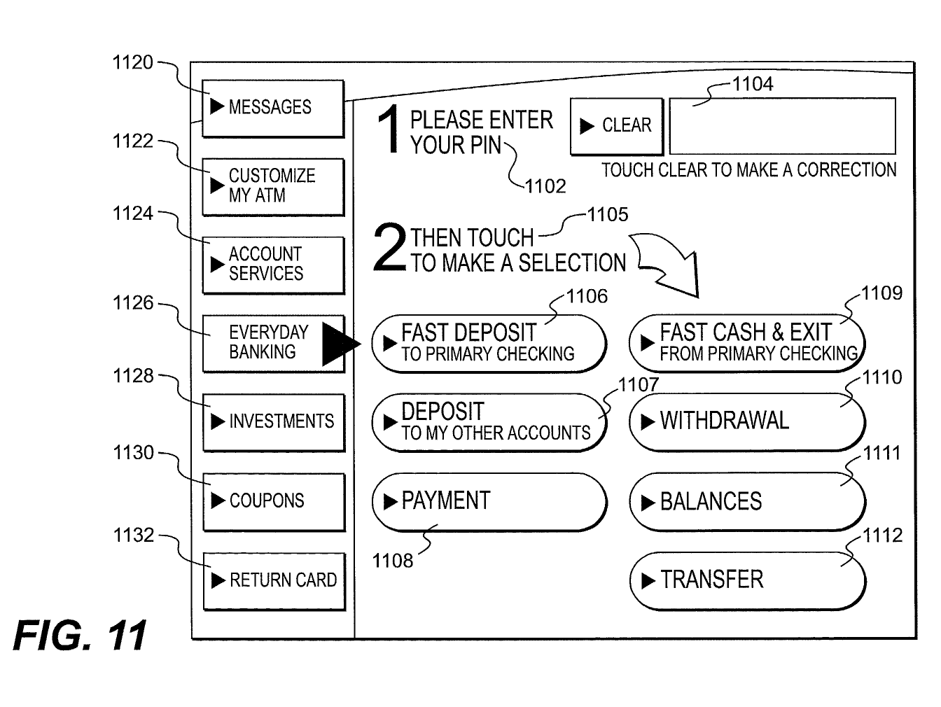

FIG. 11 depicts an exemplary user interface screen suitable for retrieving the PIN entry and transaction selection input from the user in a “quick transaction” in accordance with one embodiment of the present invention. As can be seen in FIG. 11, the user is prompted (see reference number 1102) to enter a PIN, which will be shown in the space provided by the box indicated with 1104. The user is also prompted (see reference number 1105) to touch one of the transaction buttons. In this particular example, the user has the option of making “Fast Deposit” to a primary checking account (button 1106), making a deposit to another account (button 1107), making a payment (button 1108), obtaining “Fast Cash” (button 1109), making a withdrawal (button 1110), checking balances (button 1111), or transferring funds (button 1112). The user also has the option of using numerous other services, such as checking messages (button 1120), customizing user interface screens (button 1122), checking accounts (button 1124), checking investments (button 1128), receiving coupons (button 1130) and retrieving the access card (button 1132). In a preferred embodiment, touching one of these buttons (1120, 1122, 1124, 1126, 1128, or 1130) causes another menu to appear, in cascade fashion, to the right. On the screen depicted in FIG. 11, for example, the “Everyday Banking” button 1126, is selected. Pressing this button caused the PIN entry and transaction type selection screens (1106-1112) shown in FIG. 11 to be displayed. One advantage of using touchscreen technology to activate buttons and cascading menus is that the Web ATM is not limited to the number and placement of physical function keys common to traditional ATMs.

Customer Email Requests

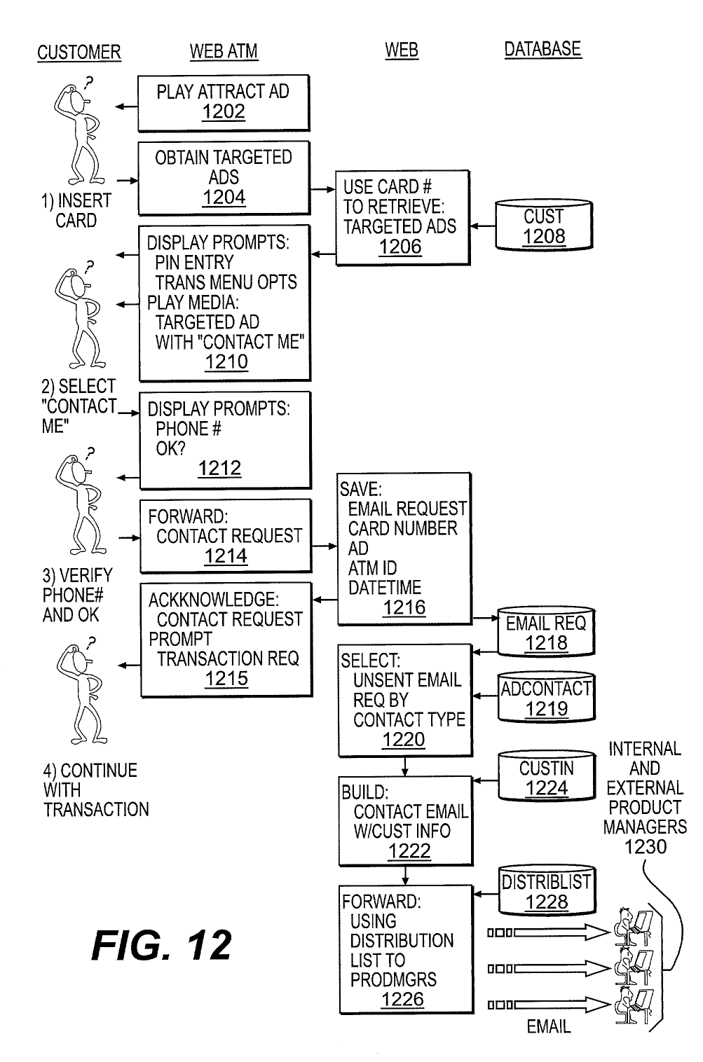

FIG. 12 illustrates the flow of data during a user session in which the user elects to send an e-mail request for additional information about a targeted ad. First, while there is no user session in progress, Web ATM 110 plays an Attract ad (step 1202), which may include “default” advertisements based, for example, on the geographic location of Web ATM 110. When a user inserts an access (or debit) card, targeted ads are obtained (step 1204). In the preferred embodiment, retrieving targeted ads comprises using the access card number to retrieve market segment or personal or financial data (step 1206) from a customer profile (database 1208). Next, at step 1210, the system prompts the user to enter a PIN and transaction type while playing the retrieved targeted ads along with a “Contact Me” button or control responsive to input from the user. If the user selects the “Contact Me” button, the system prompts the user to enter a phone number, step 1212. After the user enters and verifies the phone number, the contact request is forwarded to Web Server 130 at step 1214. In step 1216, Web Server 130 saves the email request, along with the access card number, the date and time, and information identifying the Web ATM and the targeted ad which generated the request.

At this point, the system acknowledges the contact request and prompts the user to select a transaction, step 1215. Web Server 130 retrieves the saved email request (step 1220) from. an email request database (1218), builds a contact email (step 1222) based on the contact request type for the ad (database 1219), customer information from a customer information database (1224), and a contact request distribution list (1228). The email is then forwarded, step 1226, to the appropriate person or entity (depicted as internal or external product managers 1230 in FIG. 12). One of ordinary skill in the art would recognize and appreciate that the email request can be built and forwarded to the appropriate entity substantially simultaneously with the user session or later, after the user session is complete, and that both options would fall within the scope of the present invention.

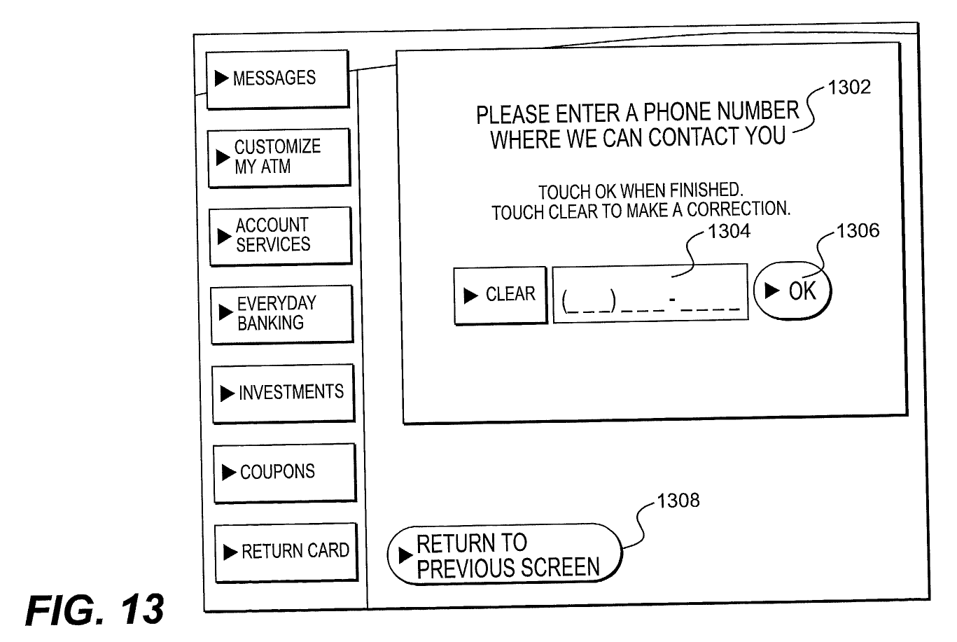

FIG. 13 depicts an exemplary user interface display screen for use with the operation described above with reference to FIG. 12, wherein the user is prompted (1302) to enter a contact phone number, which is displayed (1304) for user verification (button 1306). Alternatively, the system could be configured to display a telephone number on file, and prompt the user for verification. Through button 1308, the user is prompted to return to the previous screen.

Multiple Targeted Ads Throughout a Transaction

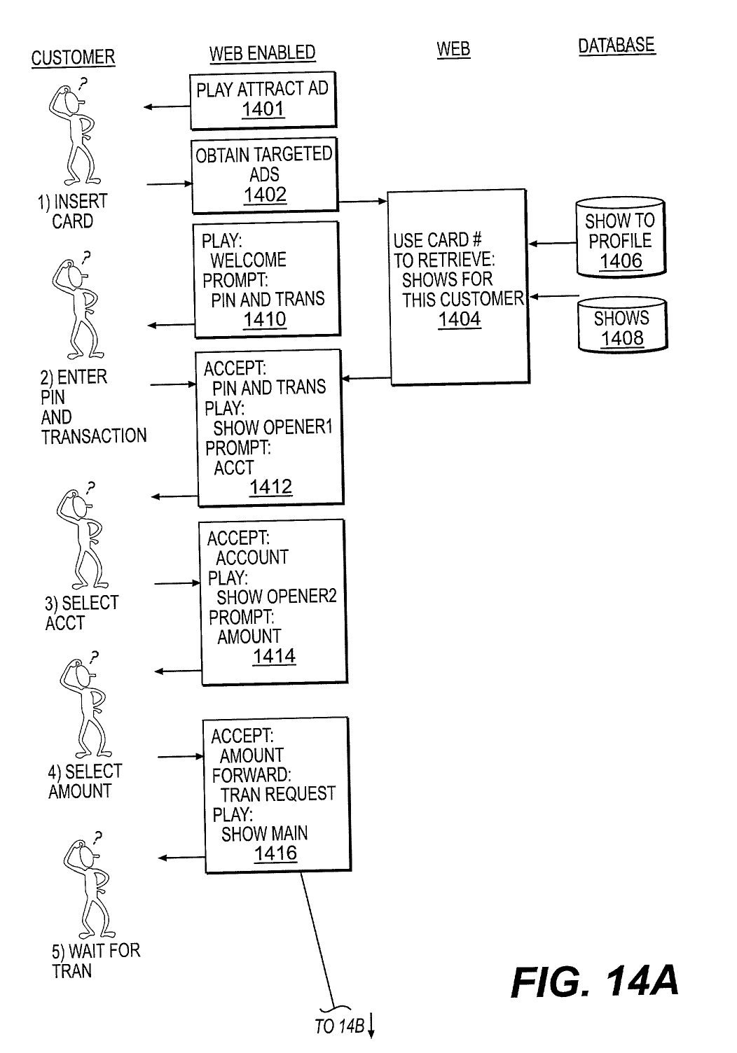

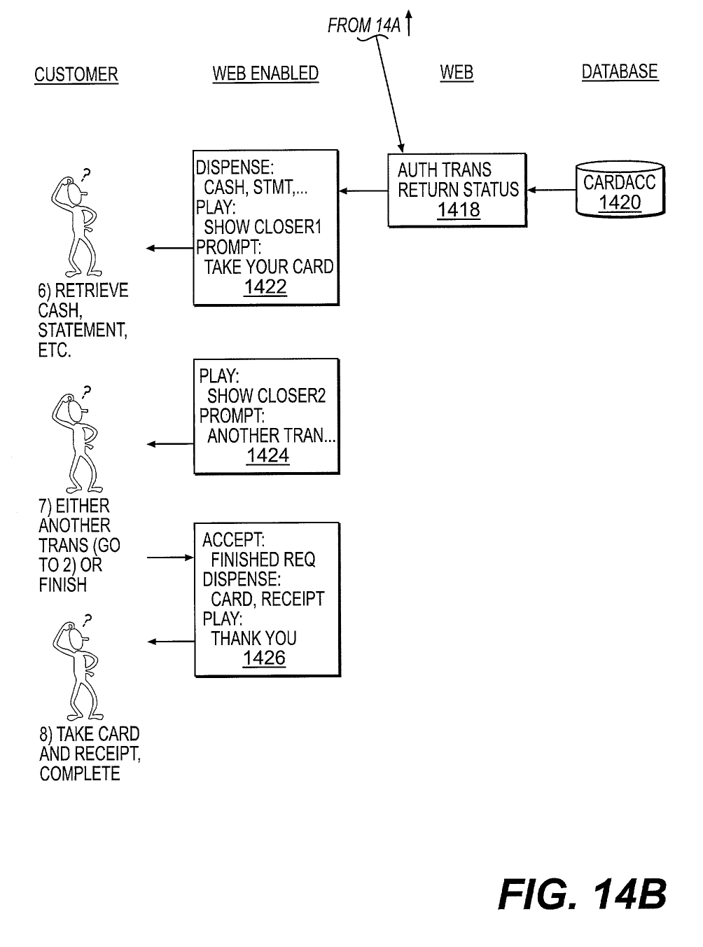

FIG. 14 shows another data flow diagram for a method of conducting a transaction on an ATM in accordance with one embodiment of the present invention. While there is no user session in progress, Web ATM 110 plays an attract ad, step 1401. When the user inserts an access (or debit) card, the card number is used to retrieve ads targeted to the user (steps 1404 and 1402) based on databases 1406 and 1408. Next, the user is presented with a “Welcome” ad and a prompt to enter a PIN and select a transaction type, step 1410. After the user enters a PIN and selects a transaction type, another ad targeted to the user is presented along with a prompt for the user to select an account (step 1412).

When the user selects an account, a third targeted ad and a prompt to enter an amount are presented (step 1414). After the user enters the amount as requested, the system forwards the transaction request to Web Server 130 and plays yet another targeted ad to the user (step 1416). In a step 1418, Web Server 130 retrieves account information from a card account database (1420) and sends a return status to Web ATM 110. Next, Web ATM 110 dispenses cash or a statement (or both) and prompts the user to retrieve the access card, while playing yet another ad (step 1422). After the user takes the cash or statement, Web ATM 110 asks the user whether another transaction is desired with still another ad (step 1424). If the user selects to initiate another transaction, process flow returns to step 1410. If the user elects to terminate the session, then Web ATM 110 dispenses the user's access card and receipt while playing a “Thank you” message (step 1426). Preferably, although not necessarily, all of the ads presented to the user in the above described session are related (in storyboard fashion) in such a way as to provide a single message to the user.

Customer Relationship-Driven Ads

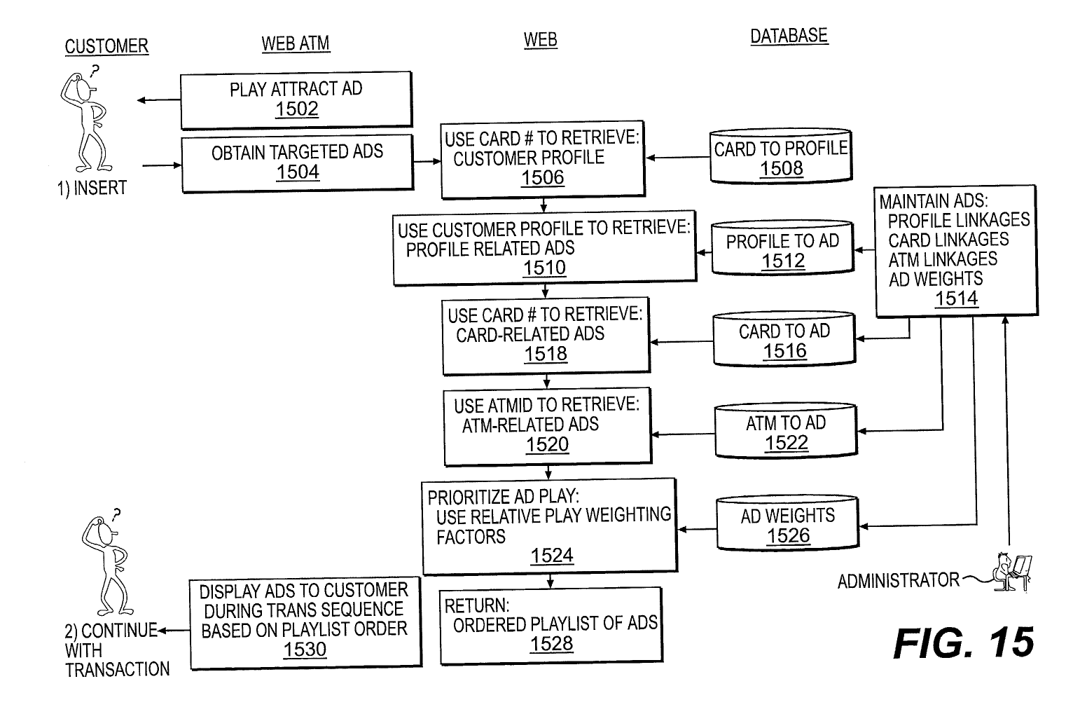

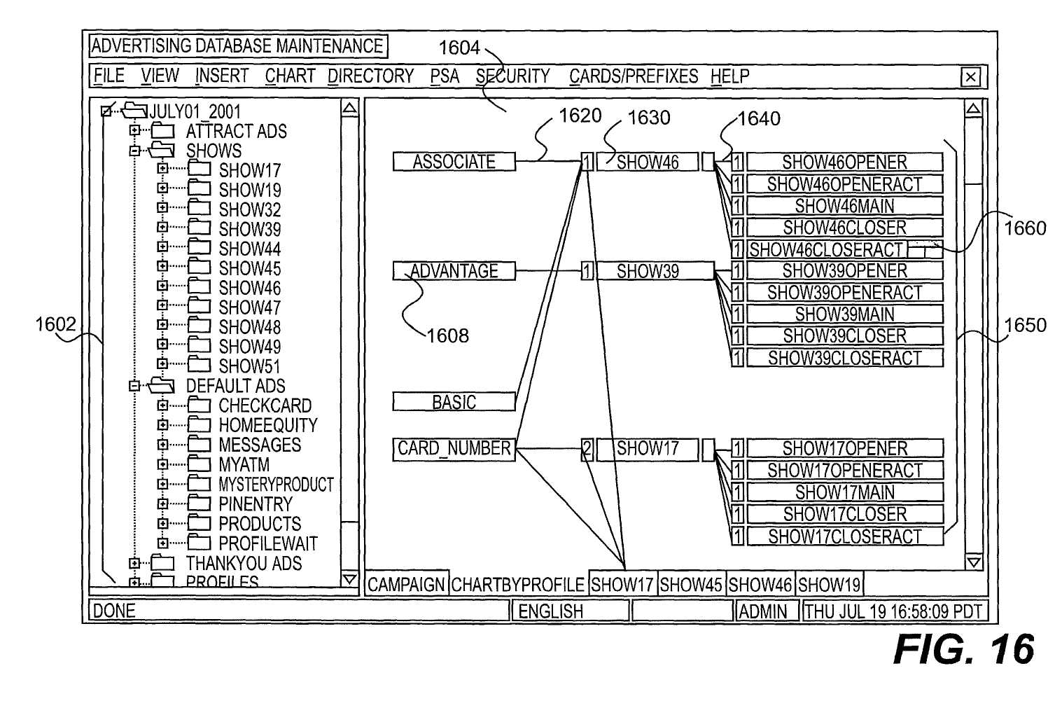

FIG. 15 shows the general data flow in a transaction conducted on an ATM in accordance with the present invention, wherein the ads presented to the user are driven by the user's relationship to the bank or other financial institution providing the ATM services. While there is no user session in progress, the Web ATM plays an attract ad (step 1502). When the user inserts an access (or debit) card, the card number is used to retrieve a customer profile from a customer profile database 1508 in steps 1504 and 1506. In step 1510, the customer profile is used to retrieve profile-related ads 1512). In step 1518, the card number is used to retrieve card-related ads from database 1516. The ATM identification number is used to retrieve ATM-related ads from database 1522. In step 1520, using relative weight factors retrieved from weight database 1526, the ads are then prioritized in step 1524 and an ordered playlist is returned to Web ATM 10, step 1528. Finally, the ordered play list is presented to the user (1530). In a preferred embodiment, an administrator uses the administrator tools (described below with reference to FIGS. 16, 17 and 18) to maintain profile linkages, card linkages, ATM linkages and ad weights (as shown in step 1514).

System Management

A preferred embodiment of the present invention would also include certain system and network management functions to ensure the availability of the ATM features and functions. Three operational areas are affected by these functions: system administration, system monitoring and system software and content distribution.

1. System Administration

FIGS. 16, 17 and 18 depict exemplary graphical user interface screens for an administrative tool that can be used by a system administrator to configure, organize and maintain ads, profiles and ad weights for the present invention. In FIG. 16, there are two content zones. The first content zone (depicted as reference 1602 in FIG. 16) is a file directory that shows all folders and objects that are contained in a campaign. A campaign is a collection of ads, shows, profiles, contacts, print files, and button text objects that, in a preferred embodiment, have a specified start and end date. This zone may be configured to remain static once a

campaign has been selected The second content zone is a main area 1604, where objects, attributes, and relationships are displayed and manipulated. Main area 1604 comprises several columns of information, including a column of profile identifiers 1608, a column of show identifiers 1630, and a column of ad identifiers 1650.

A profile identifier 1608 identifies the profiles defined for this campaign. A show identifier 1630 identifies the shows defined for this campaign. Each show has a weight (the numbered box on the left of each show identifier) and, optionally, a text file object that contains text that can be printed on the customer receipt when a show has been viewed. Advertiser data contained in the customer card number profiles, if present, will be inserted in this text file. A profile-show connector 1620 indicates a linkage between a profile and a show. This connector can also link directly to an ad (such as an attract ad).

Ad identifiers 1650 identify the ads defined for this campaign. Each ad has a weight (the numbered box to the left of the ad identifier) and , optionally, a product info text file object that may be printed when the action button is pushed. In a preferred embodiment, multiple languages may be supported. Advertiser data contained in the customer card number profiles, if present, will be inserted in this text file. Ad identifiers 1650 have one or more additional buttons 1660, which can be used to view text objects that contain the text file object in multiple languages. This button could also provide access to a contact object that defines the email address of the product manager. Linkages between shows and ads are indicated by connectors 1640.

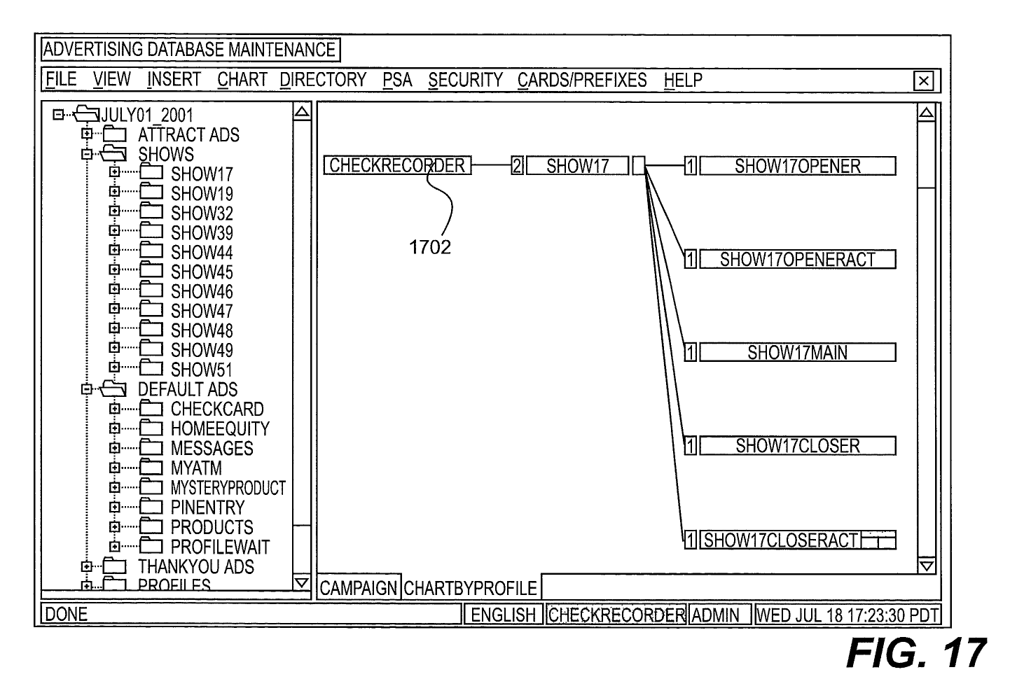

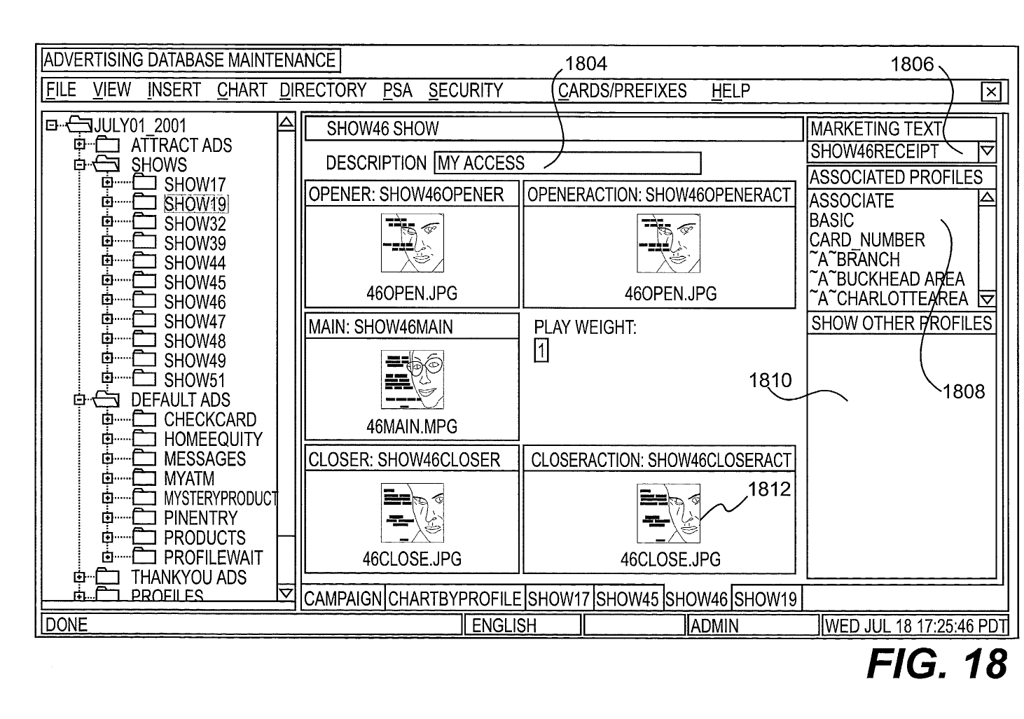

FIG. 17 is very similar to FIG. 16, except that it focuses on a particular profile 1702. Thus, FIG. 17 shows only one profile (CheckReorder) and the show and ads associated with it. FIG. 18 shows an arrangement of the particular ads (exemplified by the thumbnail image referenced as 1812) contained in a show. In this user interface screen, the administrator can see a description of the show 1804, the marketing text 1806 associated with the show and the profiles associated with a show 1808. The administrator can even add shows, if desired, by manipulating the “Show Other Profiles” control (1810).

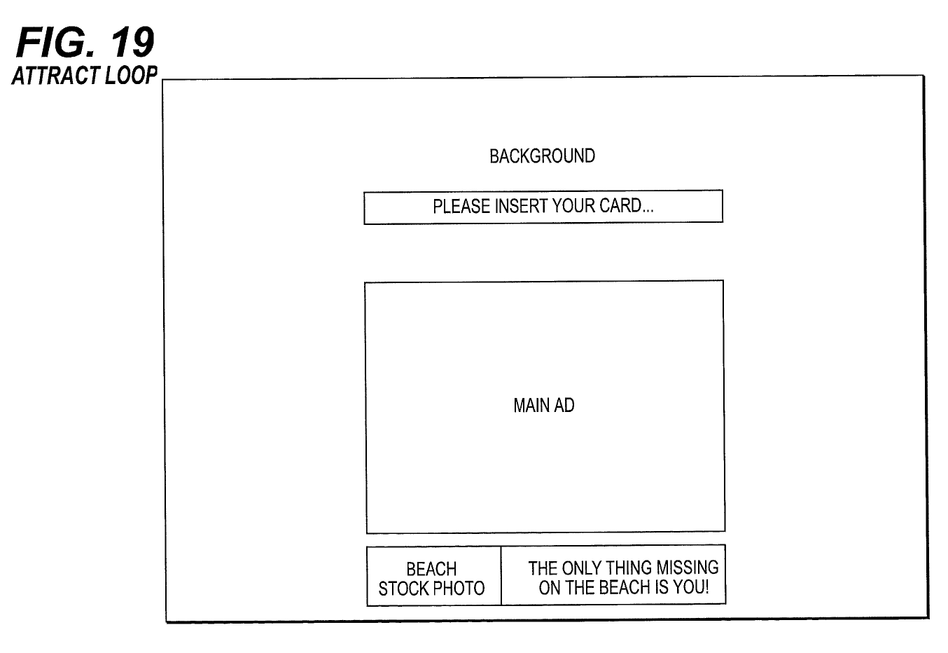

As stated above, a significant advantage of the present invention is that it provides a mechanism for a Web ATM user to respond immediately to targeted advertising. FIGS. 19-38 depict exemplary embodiments of user interface display screens which can be used with the present invention to implement the request for information features. In all of the following examples, a targeted ad plays in the “Main Ad” zone of the screen. For simplicity and clarity, however, the ads have not been reproduced in FIGS. 19-38.

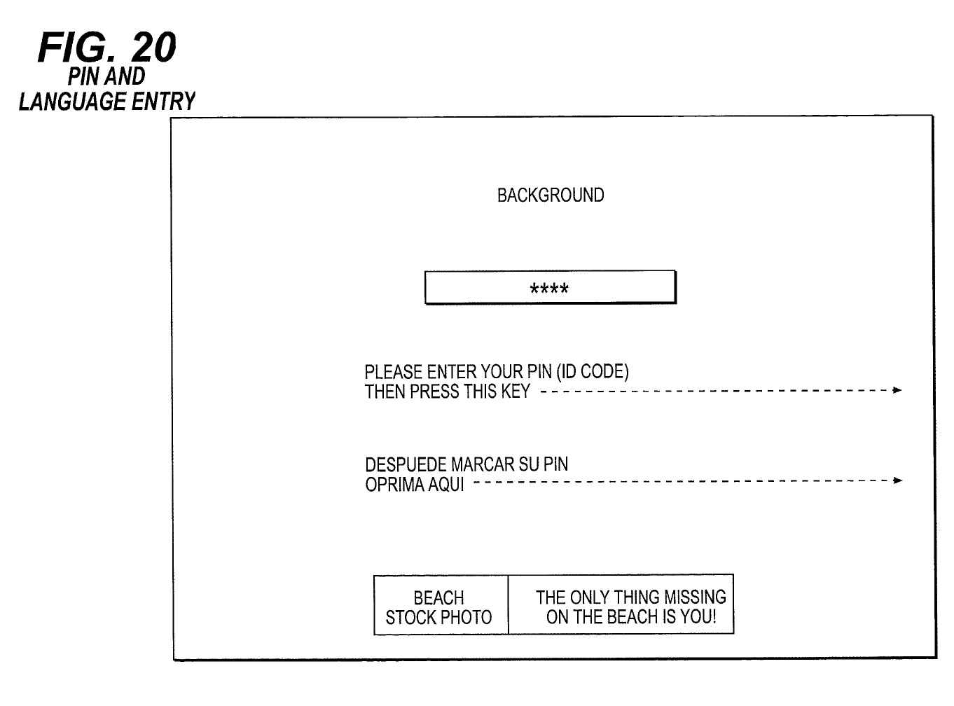

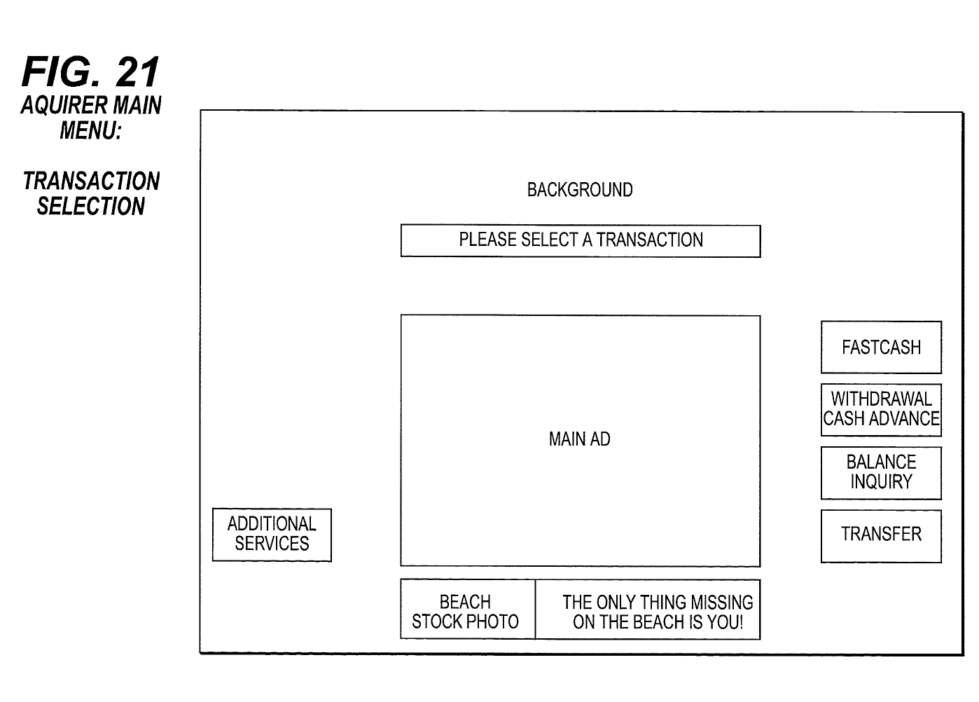

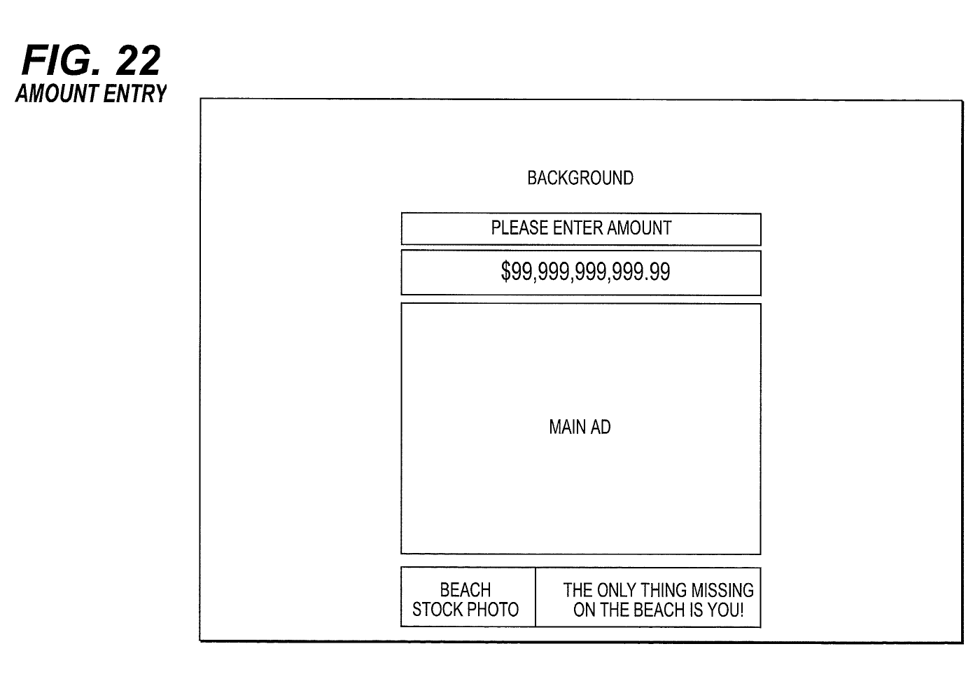

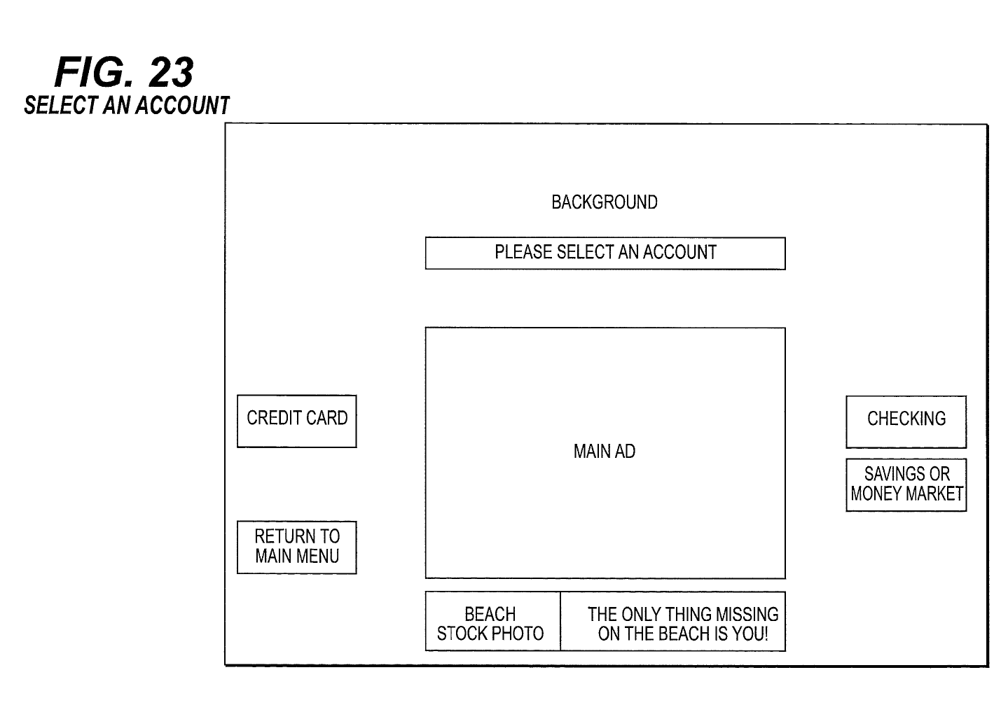

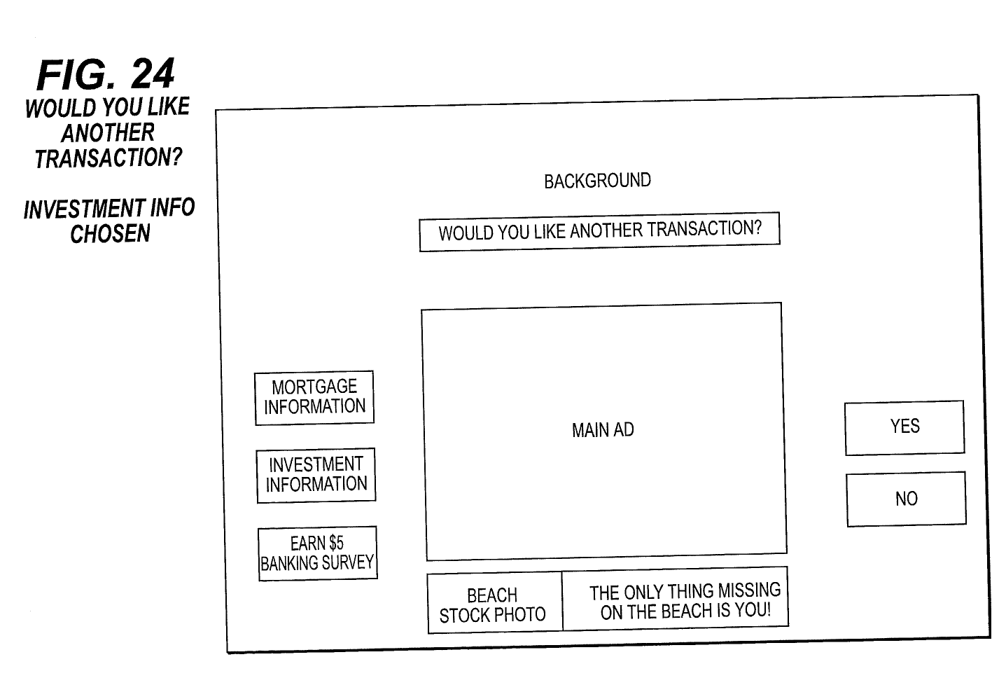

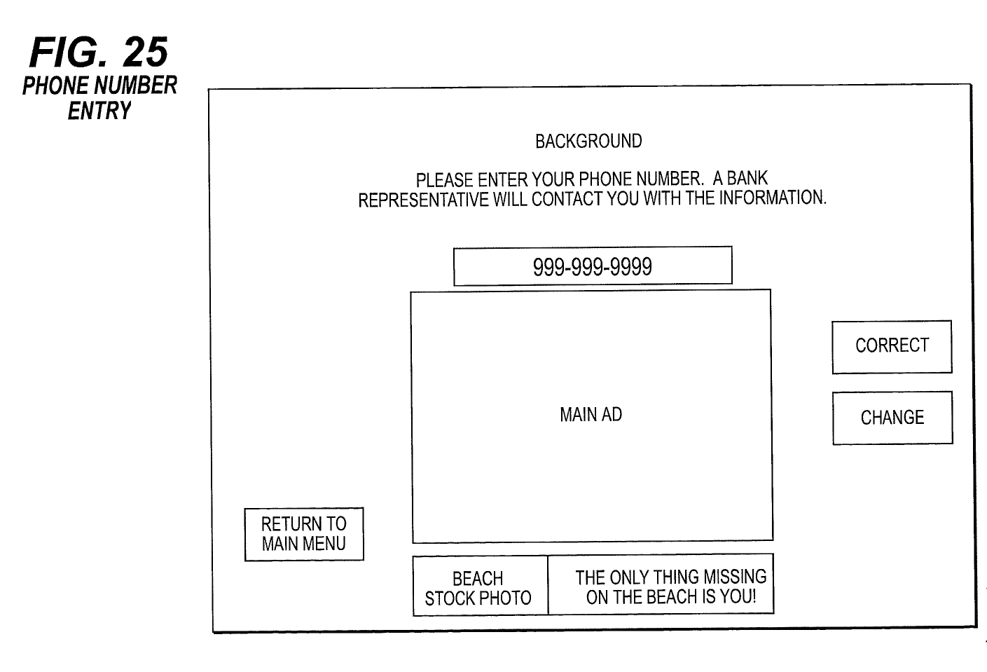

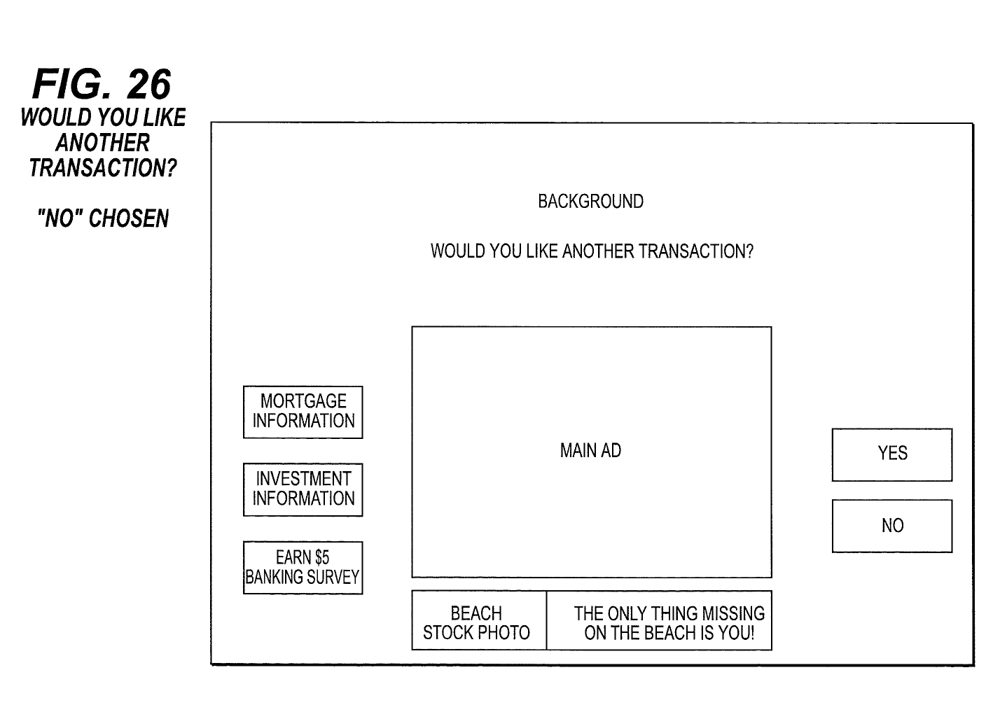

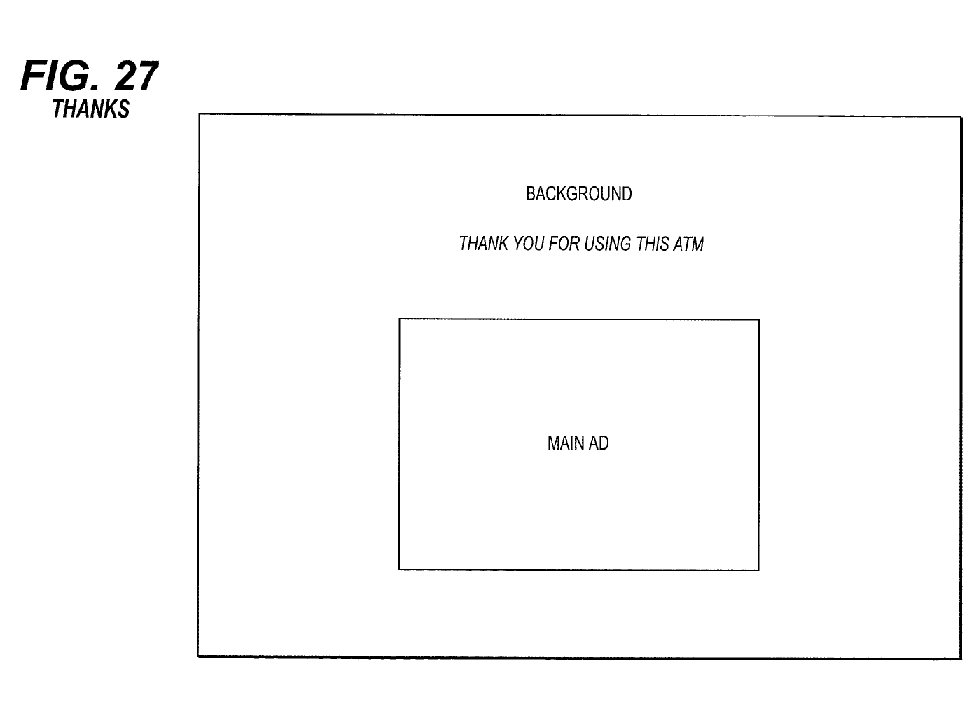

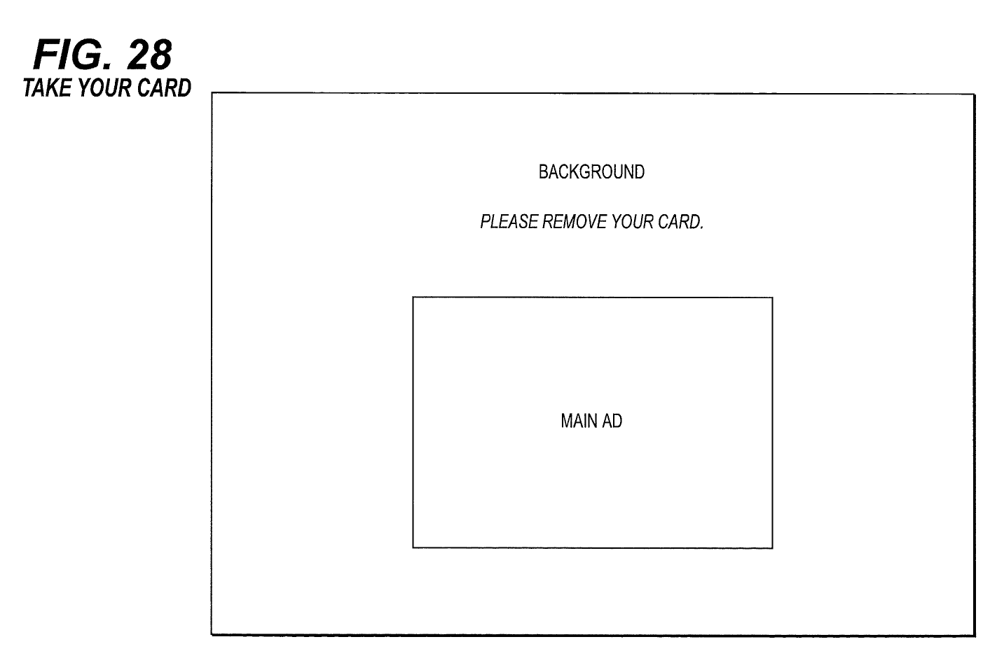

FIGS. 19 through 28 illustrate the screen flow of a cash withdrawal and investment information request transaction in which the user elects to be contacted by telephone. First, an Attract adtype plays in a loop prompting the user to insert a card, FIG. 19. When a user inserts an access or debit card, and as illustrated by FIG. 20, the user is prompted for a PIN. Next, as illustrated by FIG. 21, the user is prompted to select a transaction while an ad plays in the Main Ad zone. In the preferred embodiment, the ad continues to play when the user is prompted to enter an amount and select an account, FIGS. 22 and 23. When the user is prompted to indicate whether another transaction is desired, the system provides special buttons, illustrated in FIG. 24, which the user can push to receive information about the ad. The ad continues to play. If the user selects a button to receive additional information, the system prompts the user to enter a telephone number or verify that the number on file is correct. See FIG. 25. Then the user is returned to the “Would you like another transaction?” screen, FIG. 26. Finally, the user exits the system (FIG. 27) and retrieves his or her access card (FIG. 28).

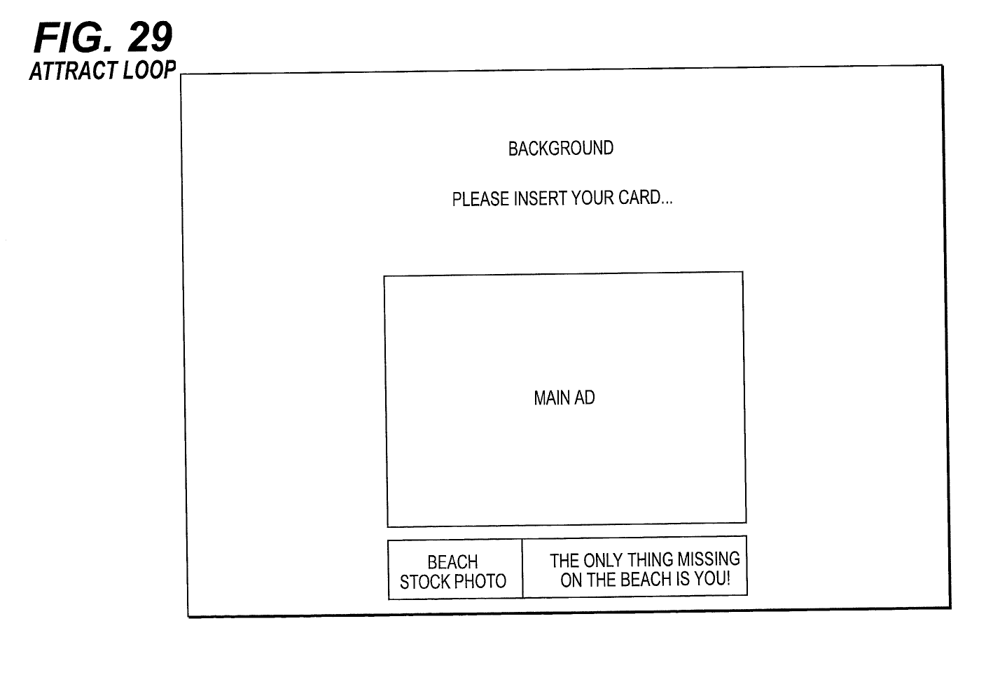

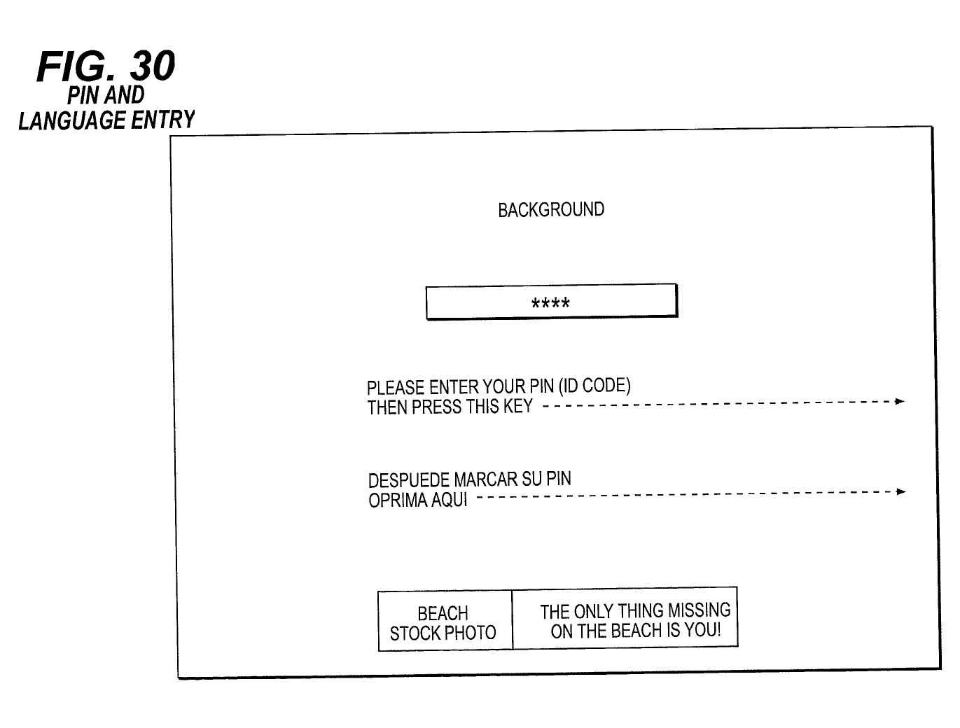

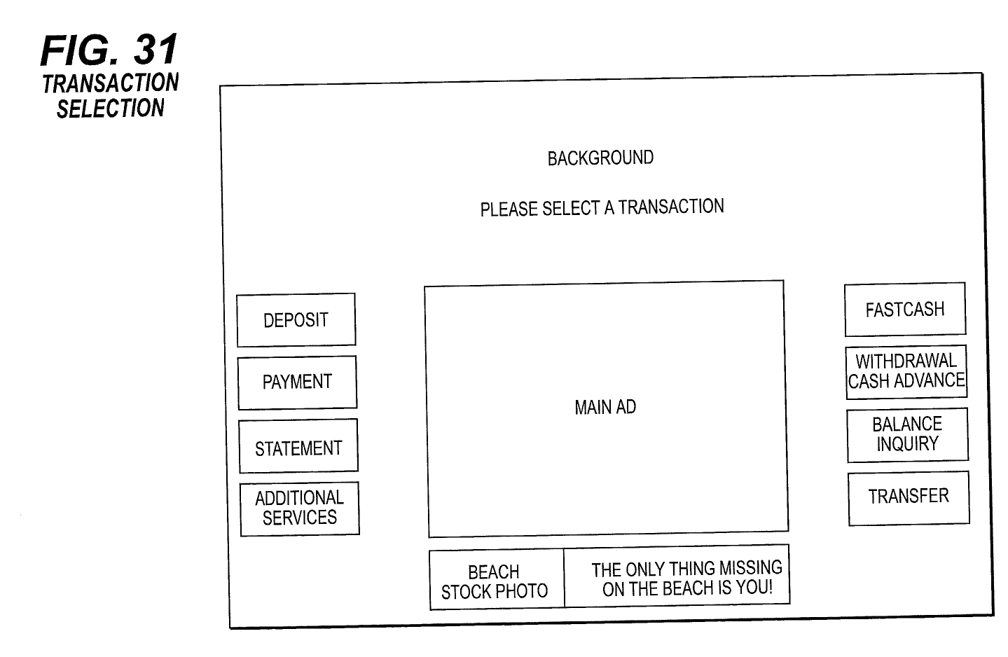

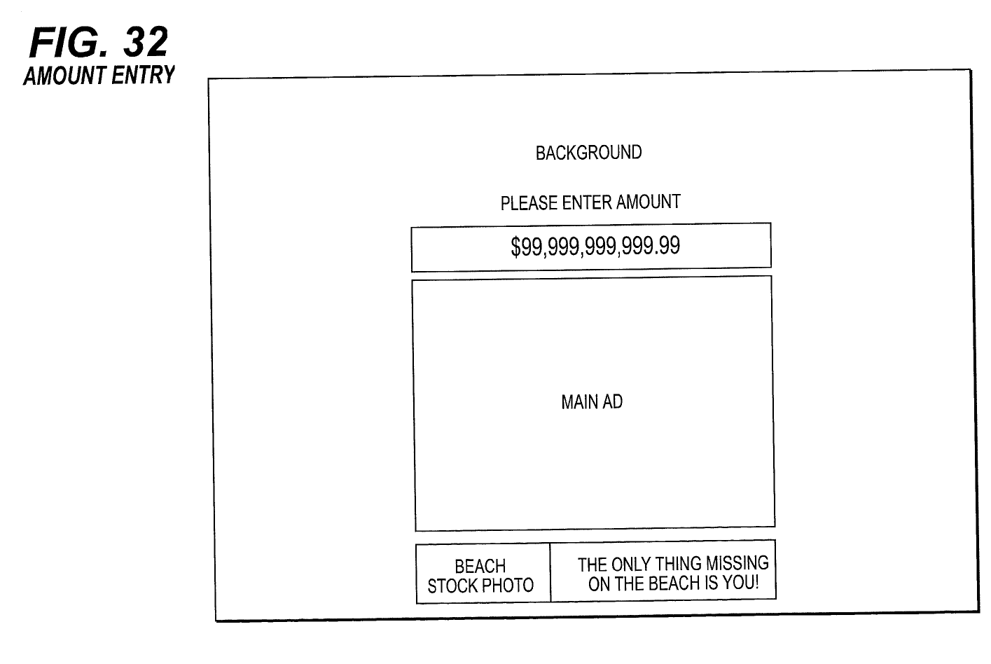

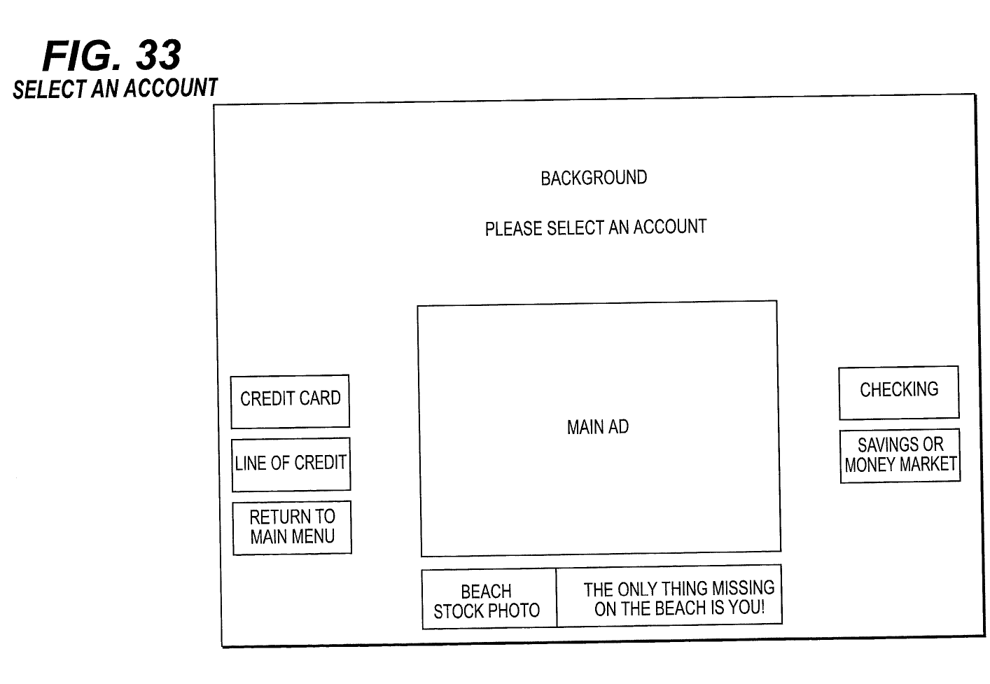

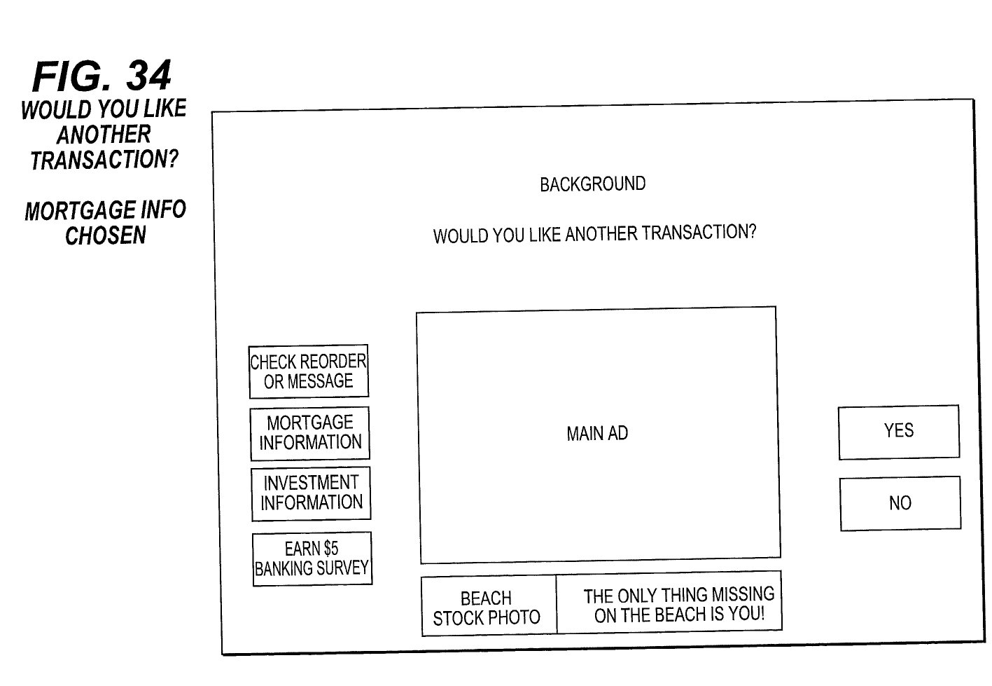

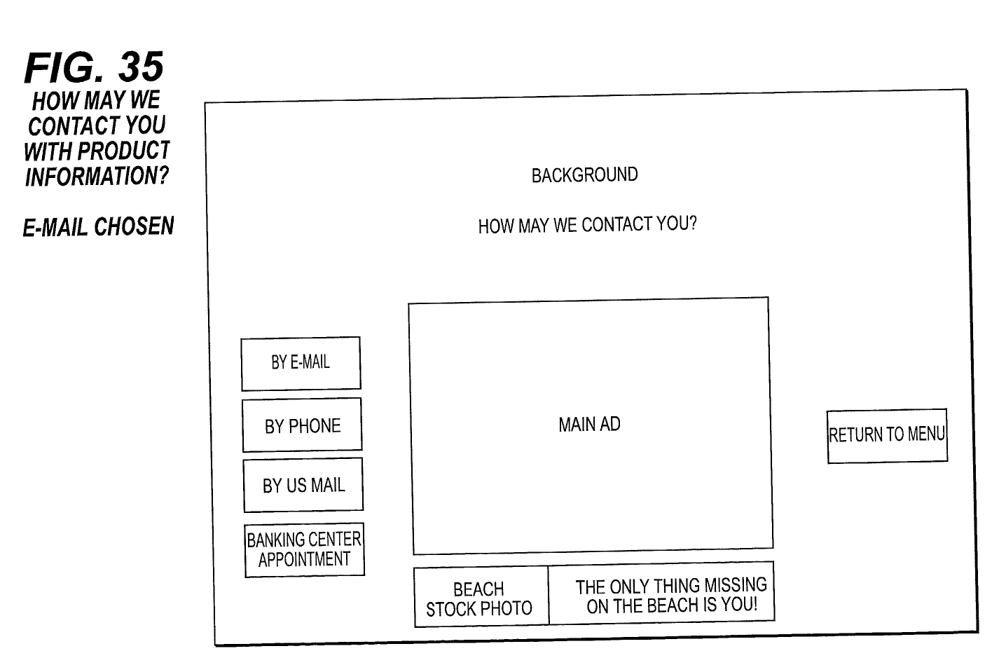

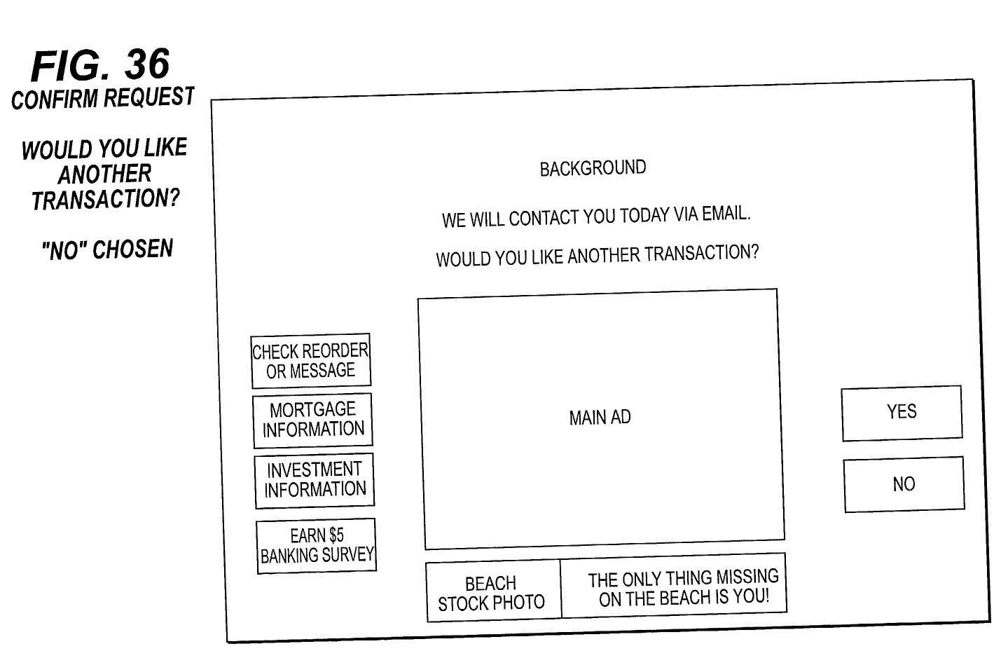

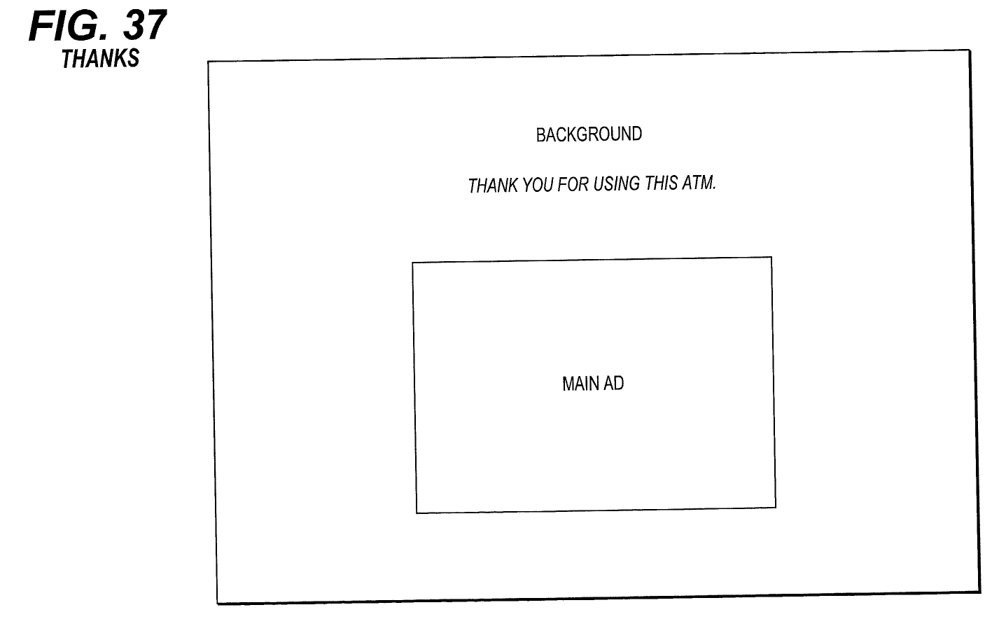

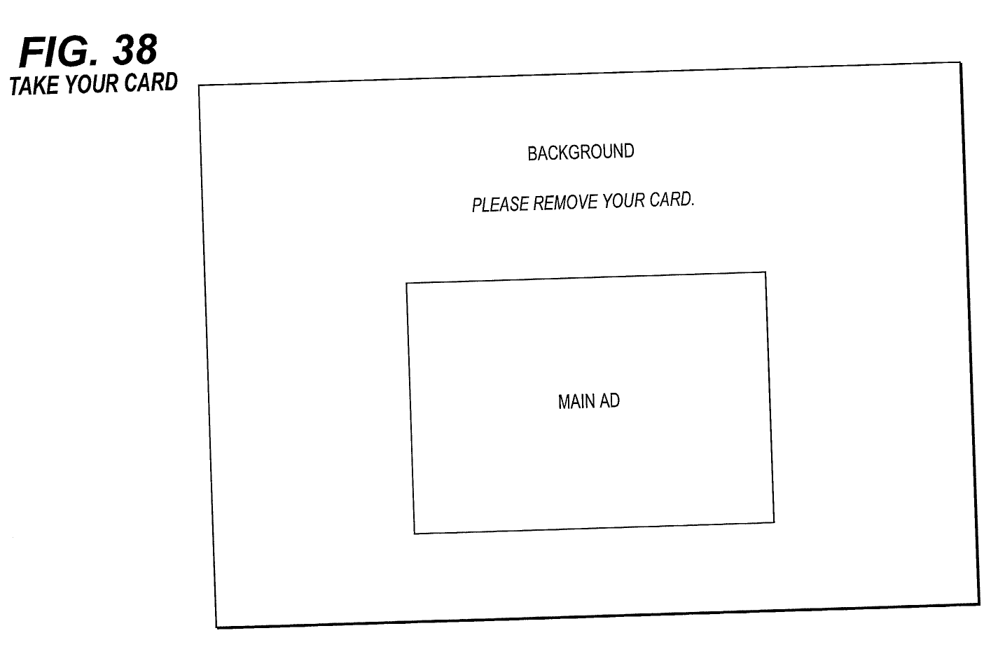

FIGS. 29 through 38 illustrate the screen flow in a deposit transaction wherein the user requests additional information about an ad and elects to be contacted by email. As before, an Attract ad is played in a loop until a user inserts an access or debit card, FIG. 29. The user is prompted to enter a PIN (FIG. 30), select a transaction (FIG. 31), enter a transaction amount (FIG. 32) and select an account (FIG. 33). In the preferred embodiment, an ad plays through FIGS. 31, 32 and 33. When the user is asked whether another transaction is desired, the system provides buttons the user can touch in order to receive additional information, FIG. 34. In this case, the user can select buttons for additional information on ordering checks, mortgages, investments and a bank survey. See FIG. 34. If the user selects one of these buttons, the system prompts the user to select the method of contact, FIG. 35. In this case, the user selected “Email,” resulting in a message confirming that an email will be sent and asking whether another transaction is desired, FIG. 36. Again, in the preferred embodiment, advertisements continue to play in the Main Ad zone throughout these transactions. If the user selects “NO” to indicate another transaction is not desired, then the session is terminated and the user's access card is returned (FIGS. 37 and 38).

2. System Monitoring

In a preferred embodiment, the Web ATM sends an alert whenever there is a loss of service by the Web Server. This is accomplished by having the Web ATM send an unsolicited event to the BASE24 Device Handler on the Web server. A monitoring system monitors the Web Server pathway, the server processes, and the TCP/IP communication layer. The monitoring system is configured to recognize and act on the unsolicited events. The monitoring system also monitors the Message Queuing (MQ) interface processes and communication links, which are used by the Web Server to access mainframe financial services data.

3. Software Distribution

In one embodiment of the present invention, certain software is resident on the Web ATM itself. In addition, there are graphic files present on the ATM to avoid the performance impact of moving large files across the network during customer interaction. Processes and procedures distribute both software and graphical files to the Web ATMs. At a minimum, such processes and procedures:

Maintain the inventory of software and graphics resident at each ATM;

Automatically distribute and install new software and graphics to one, a group, or all Web ATMs;

Back-out any changes at the Web ATM; and

Query status of the Web ATM concerning the current complement of software and graphics file versions.

The above-described preferred embodiments are intended to illustrate the principles of the invention, but not to limit its scope. Various other embodiments, modifications and equivalents to these preferred embodiments may occur to those skilled in the art upon reading the present disclosure or practicing the claimed invention. Such variations, modifications and equivalents are intended to come within the scope of the invention and the appended claims.

What is claimed is:

1. A method for presenting a show on an automated teller machine (ATM), said method comprising the steps of:
providing access to a memory area containing a plurality of show elements;
associating a subset of said plurality of show elements with a market category;
in response to activation of said ATM by a user associated with said market category;
selecting one or more show elements from said subset to form a playlist;
and displaying said one or more show elements identified by said playlist to said user.

2. The method of claim 1, wherein said market category is defined by one or more traits.

3. The method of claim 2, wherein one of said traits is possession of an access card containing a predetermined string of alphanumeric characters.

4. The method of claim 2, wherein one of said traits is a user relationship.

5. The method of claim 2, wherein one of said traits is an ATM market class.

6. The method of claim 1, wherein said step of selecting one or more show elements comprises:
retrieving a list of show elements from a profile.

7. The method of claim 6, wherein said profile comprises:
an access card identifier; and a show element identifier.

8. The method of claim 6, wherein said profile comprises:
an identifier for said user; and
a show element identifier.

9. The method of claim 6, wherein said profile comprises:
an identifier for said ATM; and
a show element identifier.

10. The method of claim 1, further comprising:
ordering said playlist prior to said step of displaying said one or more show elements.

11. The method of claim 10, wherein said step of ordering said playlist comprises:
retrieving a weight assigned to each of said one or more show elements.

12. The method of claim 1, wherein said plurality of show elements comprises at least one advertisement.

13. The method of claim 1, wherein said plurality of show elements comprises at least one public service announcement.

14. The method of claim 1, wherein said plurality of show elements comprises at least one news article.

15. The method of claim 1, further comprising:
providing a contact device that is responsive to an input from said user; in response to said input, generating an electronic mail message containing information about said user; and
transmitting said electronic mail message.

16. The method of claim 1, further comprising:
providing a contact device that is responsive to an input from said user; in response to said input, generating an electronic mail message; and
transmitting said electronic mail message to an address specified by said user.

17. The method of claim 1, further comprising:
displaying a default set of show elements prior to activation of said ATM by said user.

18. The method of claim 17, wherein said default set of show elements is selected based on a market class for said ATM.

19. The method of claim 1, further comprising:
processing a transaction request during said step of displaying said one or more show elements.

20. The method of claim 1, wherein at least one of said one or more show elements is displayed to said user while waiting for said user to respond to a prompt to enter a personal information number.

21. The method of claim 1, wherein at least one or more show elements is displayed to said user while waiting for said user to respond to a prompt to select a transaction mode.

22. The method of claim 1, wherein at least one or more show elements is displayed to said user while waiting for said user to respond to a prompt to select an account.

23. The method of claim 1, wherein at least one or more show elements is displayed to said user while waiting for said user to respond to a prompt to retrieve a dispersed item.

24. The method of claim 1, wherein at least one or more show elements is displayed to said user while waiting for said user to respond to a prompt.

25. The method of claim 1, wherein said step of displaying said one or more show elements is carried out substantially simultaneously with at least one of the following:
prompting said user to enter a personal identification number,
prompting said user to select a transaction mode,
prompting said user to select an account,
processing a transaction request initiated by said user,
displaying a transaction request result,
dispensing an access card, and
dispensing a receipt.

26. The method of claim 1, further comprising:
prompting said user to enter a personal identification number;
prompting said user to select a transaction mode;
prompting said user to select an account;
processing a transaction request initiated by said user;
displaying a transaction request result;
dispensing an access card; and
dispensing a receipt.

27. The method of claim 1, further comprising:
retrieving a set of user preferences in response to said activation;
receiving input from said user, wherein said input consists of a personal identification number and a transaction mode entered by said user in response to instructions displayed on a single display screen; and
dispensing cash to said user.

28. A method of dispensing cash from an automated teller machine (ATM), said method comprising:
retrieving a set of user preferences from a memory area in response to an insertion of an access card into said ATM by a user;
receiving input from said user, wherein said input consists of a personal identification number and a transaction mode entered by said user in response to instructions displayed on a single display screen; and
dispensing said cash to said user.

29. The method of claim 28, wherein said set of user preferences comprises:
a language option;
a fast cash amount; and
a receipt print option.

30. A method of withdrawing cash from an automated teller machine (ATM) consisting of:
inserting an access card into said ATM;
providing a personal identification number and a transaction mode in response to a query consisting of a single display screen;
receiving said cash; and
retrieving said access card.

31. A method of withdrawing cash from an automated teller machine (ATM) consisting of:
inserting an access card into said ATM;
providing a personal identification number and a transaction mode in response to a query consisting of a single display screen;
receiving said cash;
retrieving said access card; and
receiving a receipt.

32. A method of obtaining a statement from an automated teller machine (ATM) consisting of:
inserting an access card into said ATM;
providing a personal identification number and a transaction mode in response to a query consisting of a single display screen;
receiving a printout from said ATM containing said statement; and
retrieving said card.

33. A method of conducting a transaction on an automated teller machine (ATM) comprising:
(a) displaying a show in response to activation of said automated teller machine (ATM) by a user; and
(b) performing at least one of the following substeps while carrying out step
(a), wherein none of the substeps performed in step (b) are interrupted or delayed due to the performance of step (a);
(1) prompting said user to enter a personal identification number,
(2) prompting said user to select a transaction mode,
(3) prompting said user to select an account,
(4) processing a transaction request initiated by said user,
(5) displaying a transaction request result,
(6) dispensing an access card, and
(7) dispensing a receipt.

34. An apparatus for presenting a show on an automated teller machine (ATM), comprising
a memory area containing a plurality of show elements;
a processor that monitors activity on said ATM;
wherein said processor, in response to activation of said ATM by a user associated with a market category,
retrieves one or more of said plurality of show elements from said memory area, and
presents said show elements to said user.

35. The apparatus of claim 34, wherein said market category is defined by one or more traits.

36. The apparatus of claim 35, wherein one of said traits is possession of an access card containing a predetermined string of alphanumeric characters.

37. The apparatus of claim 35, wherein one of said traits is user relationship.

38. The apparatus of claim 35, wherein one of said traits is an ATM market class.

39. An apparatus for transmitting advertisements to an automated teller machine (ATM), comprising:
a first memory area containing a plurality of advertisements;
a second memory area containing a link that associates one or more of said plurality of advertisements with a user; and
a processor, responsive to activation of said ATM by said user, that retrieves one or more of said plurality of advertisements from said first memory area based on said link, and
transmits said one or more advertisements to said ATM.
